(19) United States
(12) Patent Application Publication
(10) Pub. No.: US 2012/0254312 A1
(43) Pub. Date: Oct. 4, 2012

(54) Methods and Systems for Incentivizing, Exchanging, and Tracking Expressions of Gratitude Within a Network

(76) Inventor: Hemang Patel, Pleasanton, CA (US)

(21) Appl. No.: 13/433,358

(22) Filed: Mar. 29, 2012

Related U.S. Application Data
(60) Provisional application No. 61/469,350, filed on Mar. 30, 2011.

(51) Int. Cl. G06F 15/16

(52) U.S. Cl. 709/204

(57) ABSTRACT

A method includes receiving, by a first computing device, from a second computing device associated with a first user, a first expression of gratitude for at least one of a good and a service provided by a second user. The method includes receiving, by the first computing device, from the second computing device, a second expression of gratitude for a second at least one of a good and a service provided by a third user. The method includes providing, by the first computing device, to a third computing device associated with a fourth user, the first expression of gratitude and the second expression of gratitude for display to the fourth user.

### CROSS-REFERENCE TO RELATED APPLICATIONS

This application claims priority from U.S. Provisional Patent Application Ser. No. 61/469,350, filed on Mar. 30, 2011, entitled “Systems And Methods For Incentivizing, Exchanging And Tracking Expressions Of Gratitude Within A Network,” which is hereby incorporated by reference.

### BACKGROUND

This disclosure relates to methods and systems for incentivizing, exchanging and tracking expressions of gratitude. In one aspect, a system provides functionality allowing users to publicly or privately express thanks to other users (which may include people, organizations, services, and objects), earn points for giving thanks as well as receiving thanks, and create a network of users based on these relationships. Conventional systems typically lack means for incentivizing and exchanging and tracking expressions of gratitude for value provided by others. Further, conventional systems do not typically provide functionality for identifying networks based on exchanged expressions and facilitating community building within those networks.

### SUMMARY

In one aspect, a method includes receiving, by a first computing device, from a second computing device associated with a first user, a first expression of gratitude for at least one of a good and a service provided by a second user. The method includes receiving, by the first computing device, from the second computing device, a second expression of gratitude for a second at least one of a good and a service provided by a third user. The method includes providing, by the first computing device, to a third computing device associated with a fourth user, the first expression of gratitude and the second expression of gratitude for display to the fourth user.

In another aspect, a method includes receiving, by a first computing device, from a second computing device associated with a first user, an expression of gratitude for at least one of a good and a service provided by a second user. The method includes transmitting, by the first computing device, the expression of gratitude to a third computing device associated with the second user. The method includes modifying, by the first computing device, a score associated with the second user, based on the expression of gratitude.

In still another aspect, a method includes receiving, by a first computing device, from a second computing device associated with a first user, an expression of gratitude for at least one of a good and a service provided by a second user. The method includes transmitting, by the first computing device, the expression of gratitude to a third computing device associated with the second user. The method includes adding, by the first computing device, an identification of the first user to an enumeration of users associated with the second user.

In one aspect, a method includes importing, by a computing device, data identifying a relationship between a first user and a second user. The method includes automatically generating, by the computing device, an expression of gratitude from the first user to the second user, based upon the imported data. The method includes creating, by the computing device, a relationship between two users based on the automatically generated expression of gratitude.

In another aspect, a method includes providing, by a first computing device, to a second computing device associated with a first user, an enumeration of opportunities to provide at least one of a good and a service in exchange for at least one expression of gratitude. The method includes receiving, by the first computing device, from a third computing device associated with a second user, an expression of gratitude for the at least one of the good and the service provided by the first user. The method includes providing, by the first computing device, to the second computing device, the first expression of gratitude.

In still another aspect, a method includes providing, by a first computing device, to a second computing device associated with a first user, an enumeration of offers to provide an expression of gratitude in exchange for receiving at least one of a good and a service. The method includes receiving, by the first computing device, from the second computing device, the expression of gratitude for the at least one of the good and the service provided by a second user. The method includes providing, by the first computing device, to a third computing device, associated with the second user, the expression of gratitude.

In another aspect, a method includes receiving, by a first computing device, from a second computing device associated with a first user, an expression of gratitude for value provided by an object. The method includes providing, by the first computing device, to a third computing device associated with a second user, the expression of gratitude for display to the second user.

In a further aspect, a system includes a client device and a remote machine. In one embodiment, the remote machine executes at least one of an expression generation engine, an expression history interface, a network visualization component, a gift exchange engine, an influence and trust calculation engine, a statistical calculation and caching engine, a relationships engine, an updates engine, an object engine, and a search engine.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B-1C are block diagrams depicting embodiments of computers useful in connection with the methods and systems described herein;

FIG. 2A is a block diagram depicting an embodiment of a system for incentivizing, exchanging and tracking expressions of gratitude;

FIG. 2B is a block diagram depicting an embodiment of a network for incentivizing, exchanging, and tracking expressions of gratitude that can exchange data with other networks;

FIG. 2C is a block diagram depicting one embodiment of a user's profile screen;

FIG. 2D is a block diagram depicting one embodiment of a system for displaying an expression of gratitude associated with a person calling a user on a mobile device of the user;

FIG. 2E is a block diagram depicting one embodiment of a system for displaying widgets on a third party service;

FIG. 2F is a block diagram depicting one embodiment of a home page screen;

FIG. 2G is a block diagram depicting another embodiment of a home page screen;

FIG. 2H is a block diagram depicting an embodiment of a user's profile screen;

FIG. 2I is a block diagram depicting one embodiment of a user's profile screen;

FIG. 2J is a flow diagram depicting one embodiment of a method for providing, to one user, expressions of gratitude sent by a first user to a plurality of recipients;

FIG. 3A is a flow diagram depicting one embodiment of a system for generating and transmitting an expression of gratitude;

FIG. 3B is a block diagram depicting one embodiment of a system for searching thank you(s) by topic with options to filter the search results by tribe and network, including a display of search results for the topic “project”, shown in order of relevance for the user performing the search;

FIG. 3C is a flow diagram depicting one embodiment of a method for giving a gift with an expression of gratitude;

FIG. 3D is a block diagram depicting one embodiment of a user's profile screen including a wish list interface;

FIG. 3E is a flow diagram depicting one embodiment of a method for providing an expression of gratitude;

FIG. 3F is a block diagram depicting one embodiment of a user's profile screen with a tab selected, including an interface displaying expressions of gratitude listed under the tab;

FIG. 3G is a flow diagram depicting one embodiment of a method for providing an expression of gratitude in which a user offers to provide the expression of gratitude in exchange for at least one of a good and a service;

FIG. 3H is a flow diagram depicting one embodiment of a method for expressing gratitude for value provided by an object;

FIG. 4A is a flow diagram depicting one embodiment of a method for modifying a score based on an expression of gratitude;

FIG. 4B is a flow diagram depicting one embodiment of a method for interacting on a gratitude network;

FIG. 4C is a block diagram depicting one embodiment of a user's profile screen that includes a display of awards and virtual gifts received by the user;

FIG. 4D is a flow diagram depicting one embodiment of a method for receiving and transmitting expressions of gratitude;

FIG. 5A is a block diagram depicting one embodiment of a system for importing historical expressions of gratitude;

FIG. 5B is a flow diagram depicting one embodiment of a method for creating a relationship between two users based on an automatically-generated expression of gratitude;

FIG. 6A is a flow diagram depicting one embodiment of a method for calculating a trust score;

FIG. 6B is a block diagram depicting one embodiment of a user's direct and indirect relationships with other users, distinguishing those users with whom trust may be calculated from those with whom influence may be calculated;

FIG. 7 is a flow diagram depicting one embodiment of a method for giving an expression of gratitude to a non-user;

FIG. 8 is a flow diagram depicting one embodiment of a method for a third party to access information from a network in which expressions of gratitude are exchanged;

FIG. 9A is a block diagram depicting one embodiment of a system for displaying expressions of gratitude associated with locations and places visually on a map;

FIG. 9B is a block diagram depicting one embodiment of a system for displaying expressions of gratitude associated with locations and places on a mobile device;

FIG. 10 is a block diagram depicting one embodiment of an interface providing social context on a user's home page;

FIG. 11 is a block diagram depicting one embodiment of a system in which multiple public and private networks for exchanging expressions of gratitude are in communication with each other; and

FIG. 12 is a flow diagram depicting one embodiment of a method for confirming a user's membership to a network.

### DETAILED DESCRIPTION

In one embodiment, an individual, entity, organization, community, object, or service may be referred to as a “user.” In one embodiment, any person, entity, or object that is a member of a Thank You Network may be referred to as a “user.” In some embodiments, the term “Thank You Network” as used herein refers to a system for publicly or privately sending and receiving expressions of gratitude, earning points for giving and receiving thanks, and creating relationships between users through this exchange as well as by joining networks that represent relationships not necessarily based on an exchange of expressions of gratitude. Unlike the usual social networks, relationships between users of a Thank You Network may or may not be bilateral although they may be created through the exchange of an expression of gratitude. Users of a Thank You Network may also be affiliated through membership in shared networks. In some embodiments, an expression of gratitude is exchanged. In other embodiments, however, expressions of other emotions are exchanged. In one of these embodiments, by way of example, expressions of appreciation are exchanged; for example, a first user may appreciate an object.

In some embodiments of the methods and systems described herein, users generate expressions of gratitude. In one embodiment, an expression of gratitude may be referred to as a “Thank You.” In one embodiment, individuals, entities, or organizations that are members of a Thank You Network create a profile on which other individuals, entities, or organizations that are members of a Thank You Network (described below) can express thanks. In another embodiment, the system automatically generates profiles for users (which, again, may include people, organizations, services, communities, networks, and objects). In another embodiment, a user can also express thanks to another user from his home page.

In one embodiment, a collection of individuals that are related by some religious, social, political, professional, geographic, interests, education, user-defined criteria, or other affiliation are referred to as a “Network.” Individuals within a network may or may not be part of each other's other communities. A user may be a part of multiple networks. In one embodiment, a “Thank You Network” is used as an umbrella term for a system for giving and receiving Thank You(s) and a “Network” is a logical component within that Thank You Network which shows relationships between users of a Thank You Network other than those created by the exchange of a Thank You. In another embodiment, a network is a type of community.

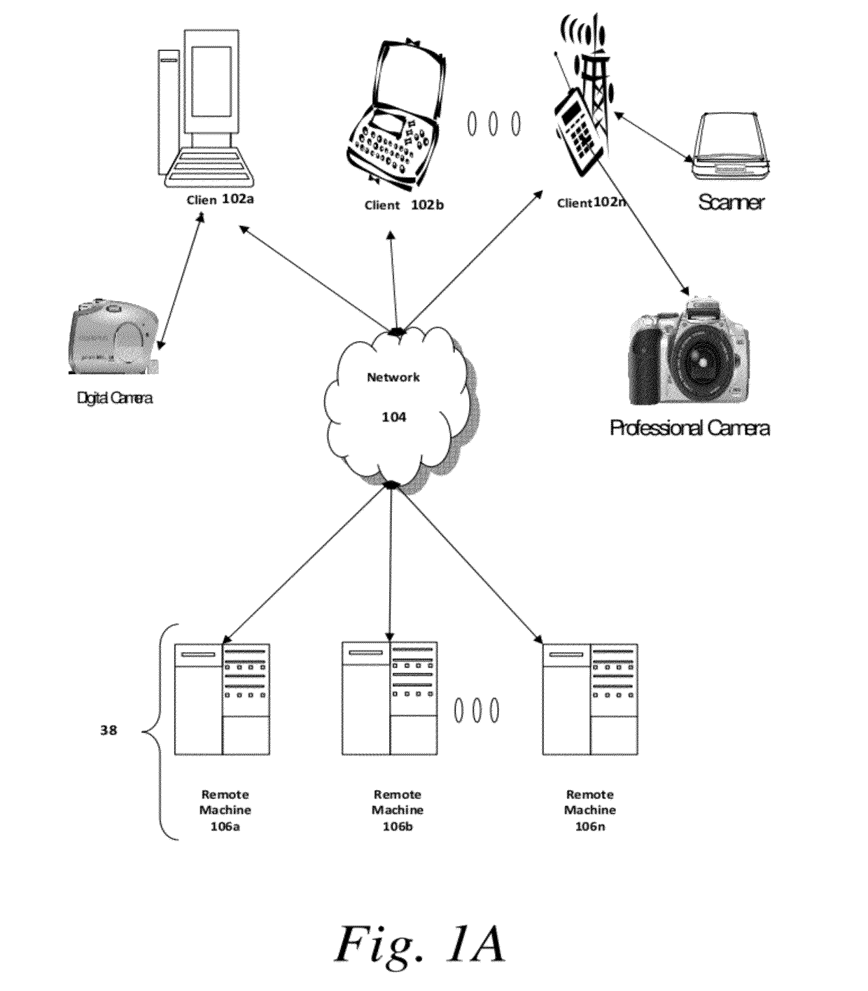

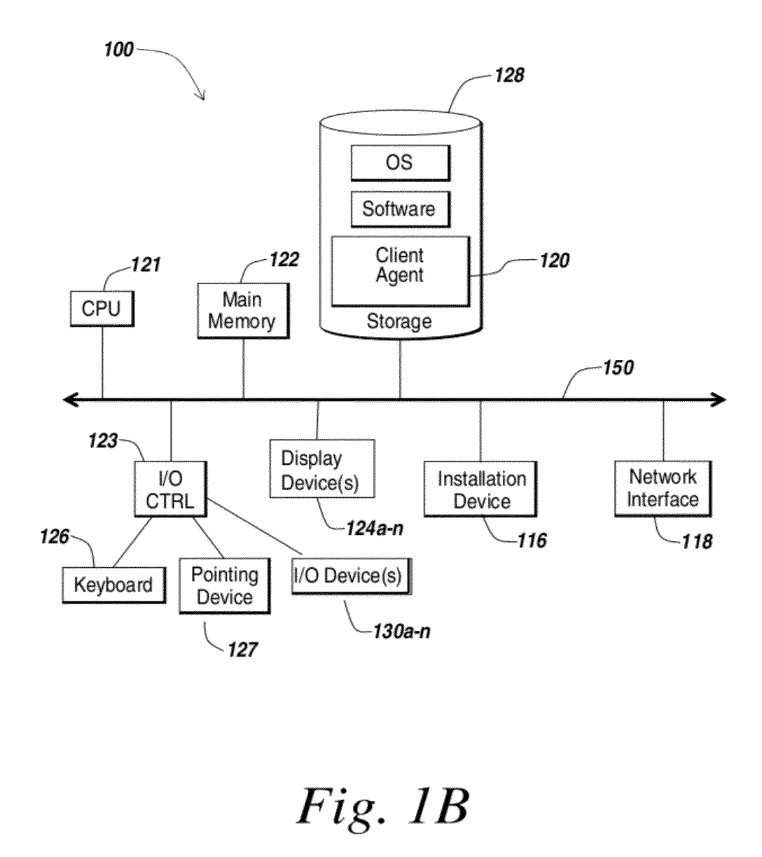

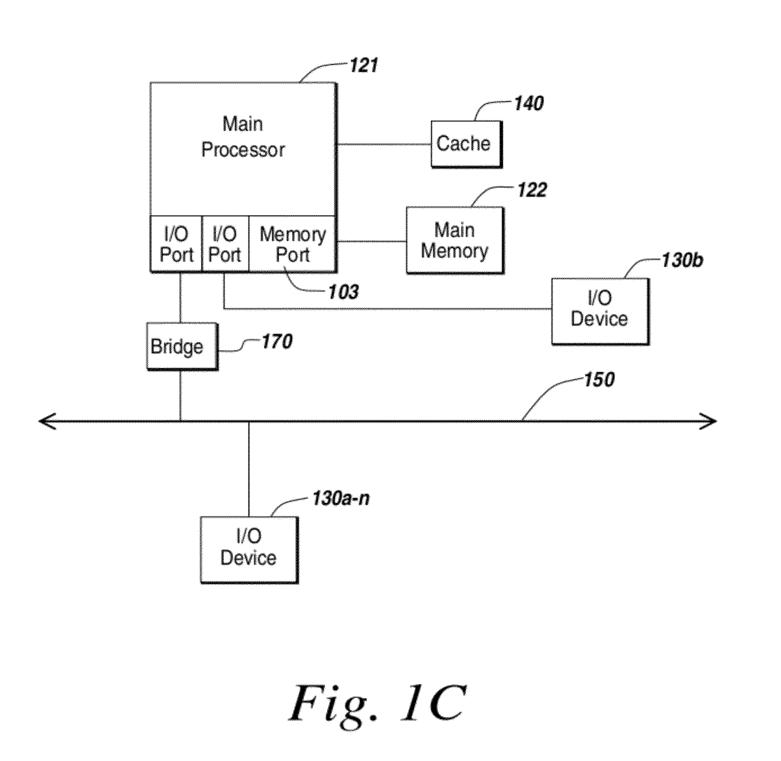

Before describing methods and systems for incentivizing, exchanging, and tracking expressions of gratitude in detail, a description is provided of a network in which such methods and systems may be implemented. Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more remote machines 106a-106n (also generally referred to as server(s) 106 or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104, and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

In some embodiments, the system may include multiple, logically grouped remote machines 106. In one of these embodiments, the logical group of remote machines may be referred to as a server farm 38. In another of these embodiments, the remote machines 106 may be geographically dispersed. In other embodiments, a server farm 38 may be administered as a single entity. In still other embodiments, the server farm 38 comprises a plurality of server farms 38. The remote machines 106 within each server farm 38 can be heterogeneous—one or more of the remote machines 106 can operate according to one type of operating system platform (e.g., WINDOWS NT, manufactured by Microsoft Corp. of Redmond, Wash.), while one or more of the other remote machines 106 can operate on according to another type of operating system platform (e.g., UNIX or LINUX).

The remote machines 106 of each server farm 38 do not need to be physically proximate to another remote machine 106 in the same server farm 38. Thus, the group of remote machines 106 logically grouped as a server farm 38 may be interconnected using a wide-area network (WAN) connection or a metropolitan-area network (MAN) connection. For example, a server farm 38 may include remote machines 106 physically located in different continents or different regions of a continent, country, state, city, campus, or room. Data transmission speeds between remote machines 106 in the server farm 38 can be increased if the remote machines 106 are connected using a local-area network (LAN) connection or some form of direct connection.

The client 102 and remote machine 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, and a pointing device 127, such as a mouse. The storage device 128 may include, without limitation, an operating system, software, and a client agent 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; an RS/6000 processor, such as those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/0 device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, scanners, cameras and drawing tablets. Output devices include video displays, speakers, inkjet printers, laser printers, and dye-sublimation printers. An I/O controller 123 as shown in FIG. 1B may control the I/O devices. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, a USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, a computer 100 connects to a second computer 100′ on a network using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

In some embodiments, the computer 100 communicates with the computer 100′ when providing a user with a service made available by the Global System for Mobile Communications (GSM) standard. In other embodiments, the computer 100 provides a user with a short message service (SMS). In one of these embodiments, the computer 100 may transmit messages to the second computer 100′ via an intermediate computer 100″, such as a short message service center. In another of these embodiments, the computer 100 may transmit messages to the second computer 100′ according to a telecommunications protocol standard for transmitting digital data on a broadband network, such as the Signaling System 7 (SS7) protocol. In still other embodiments, the computer 100 transmits enhanced short messages to the computer 100′. In other embodiments, the computer 100 transmits text messages to the computer 100′. In one of these embodiments, the text messages comply with the GSM standard for short messages. In another of these embodiments, the computers 100, 100′, 100″ transmit text messages that do not comply with a GSM standard. In still another of these embodiments, the computer 100 transmits text messages over a control channel between the computer 100 and a cell phone tower, which forwards the text messages to the recipient computer 100′.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n.

In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7 and WINDOWS VISTA, all of which are manufactured by Microsoft Corporation of Redmond, Wash.; MAC OS, manufactured by Apple Inc., of Cupertino, Calif.; OS/2, manufactured by International Business Machines of Armonk, N.Y.; and any type and/or form of a UNIX operating system, among others.

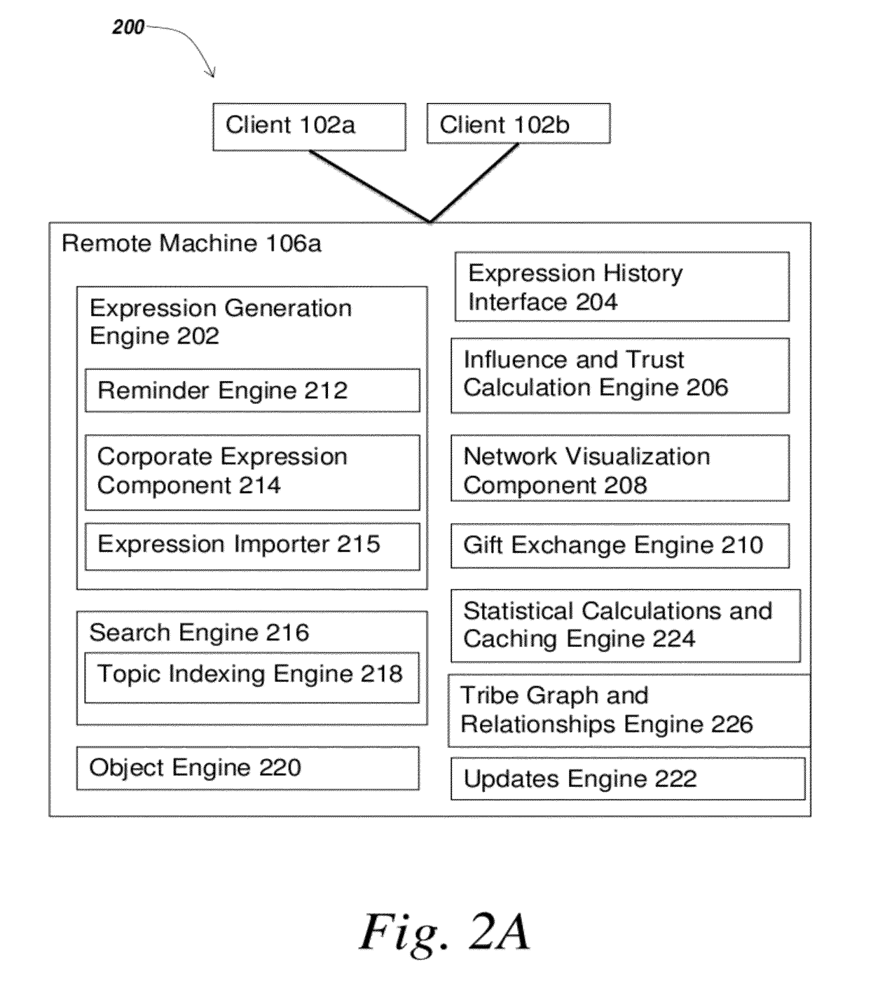

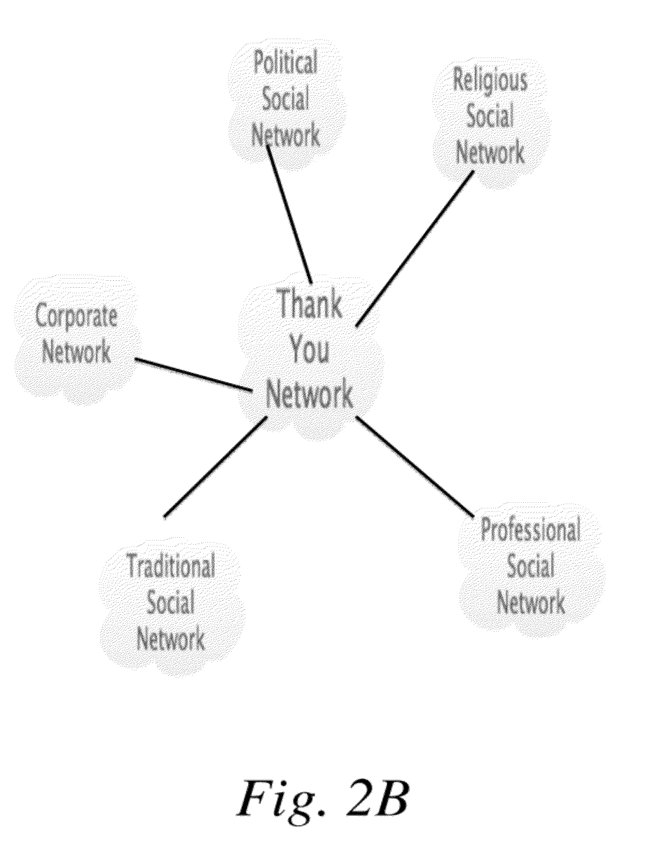

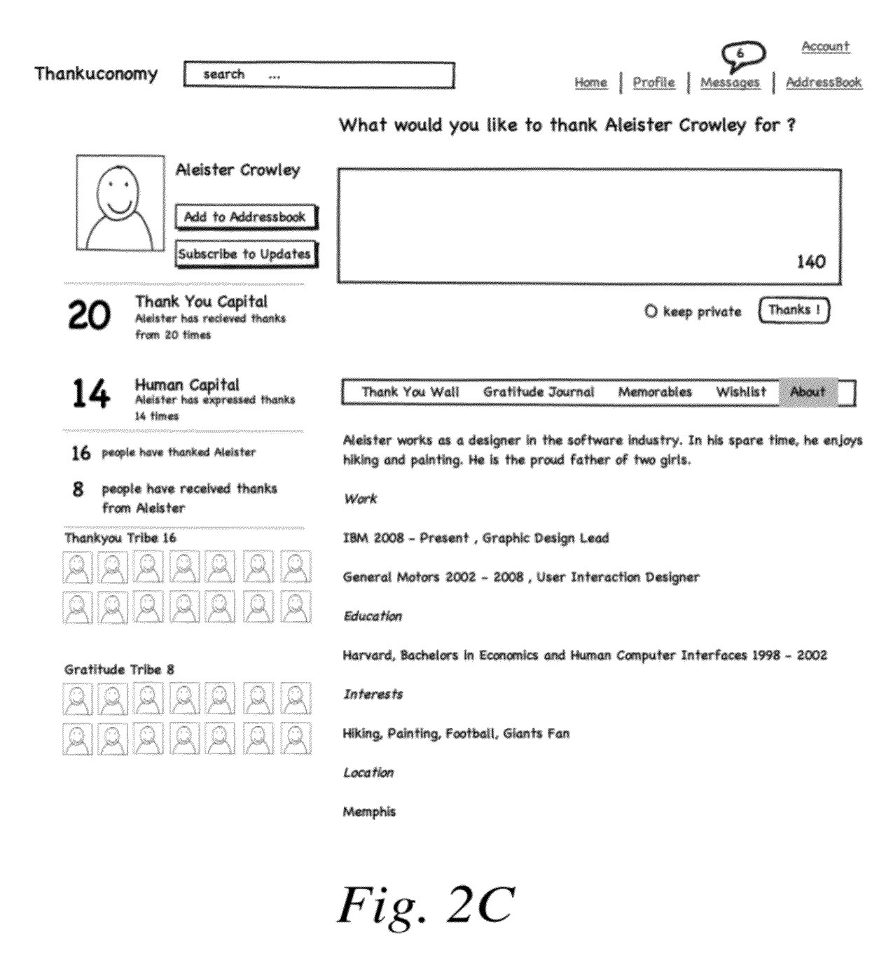

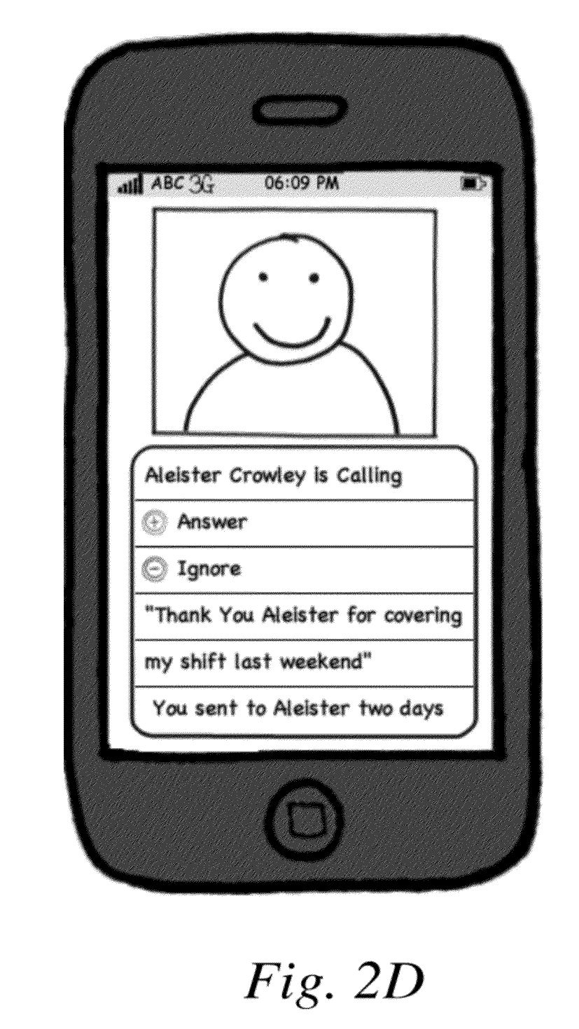

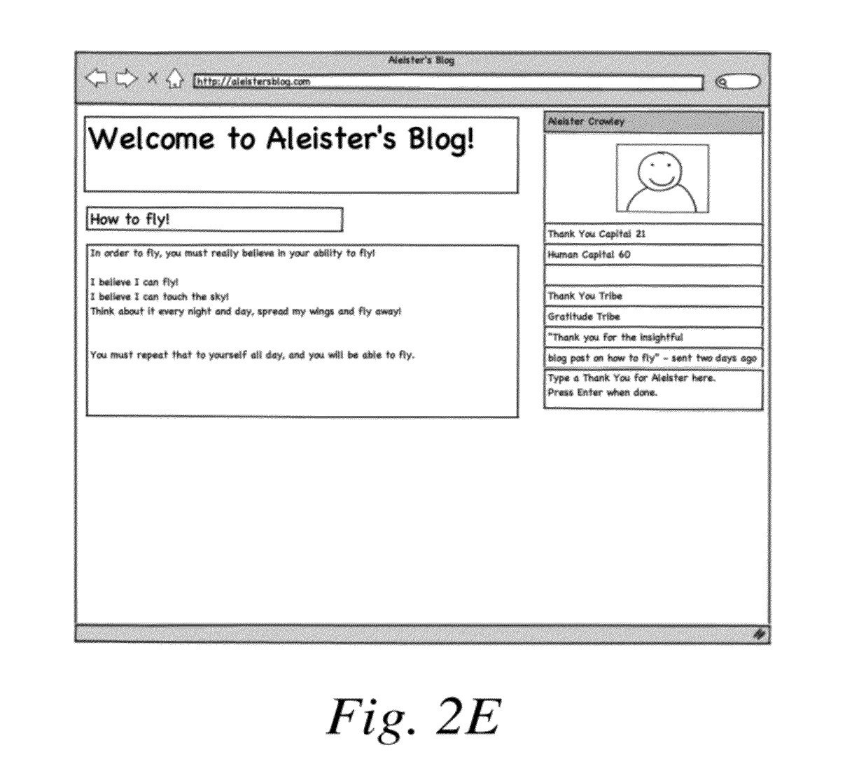

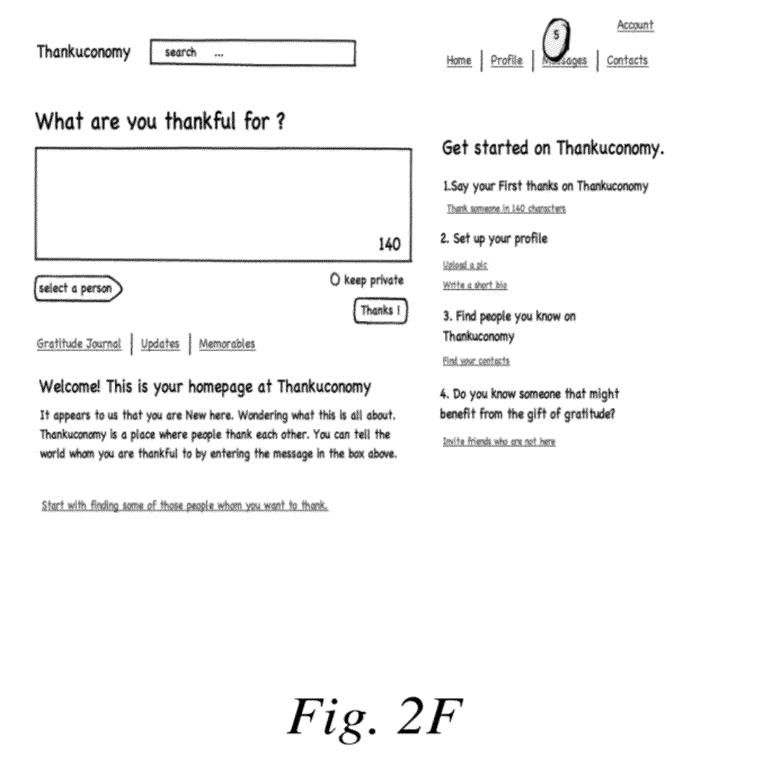

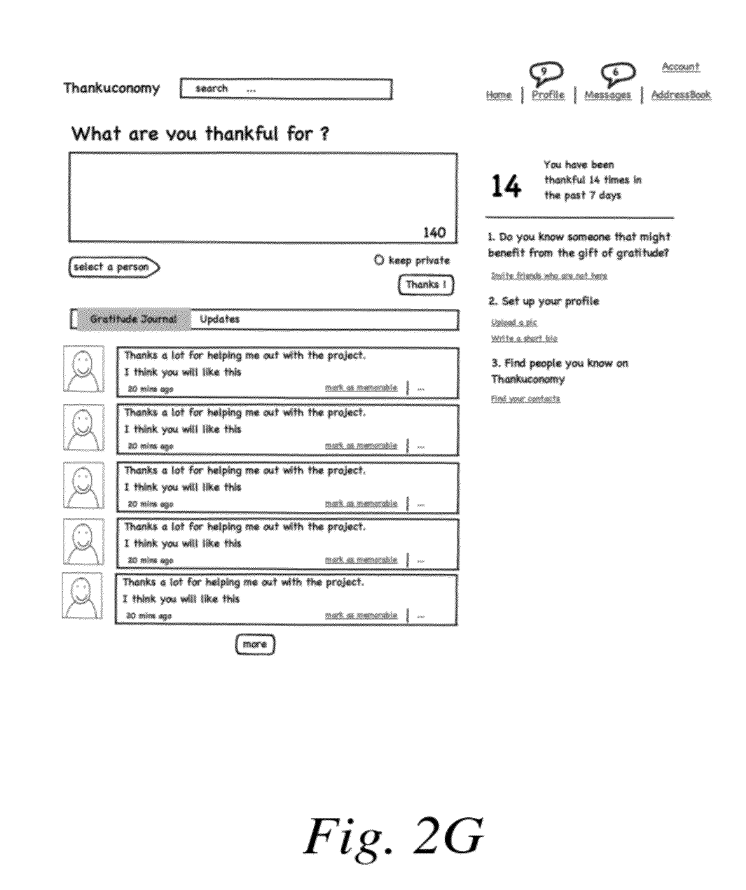

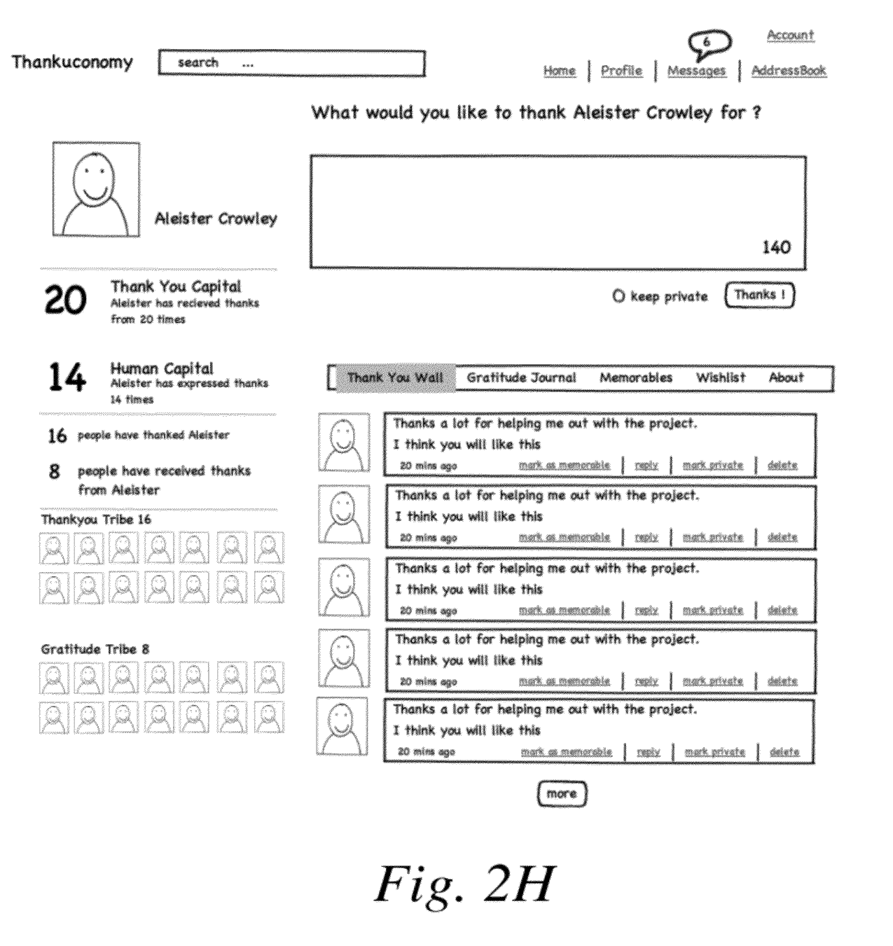

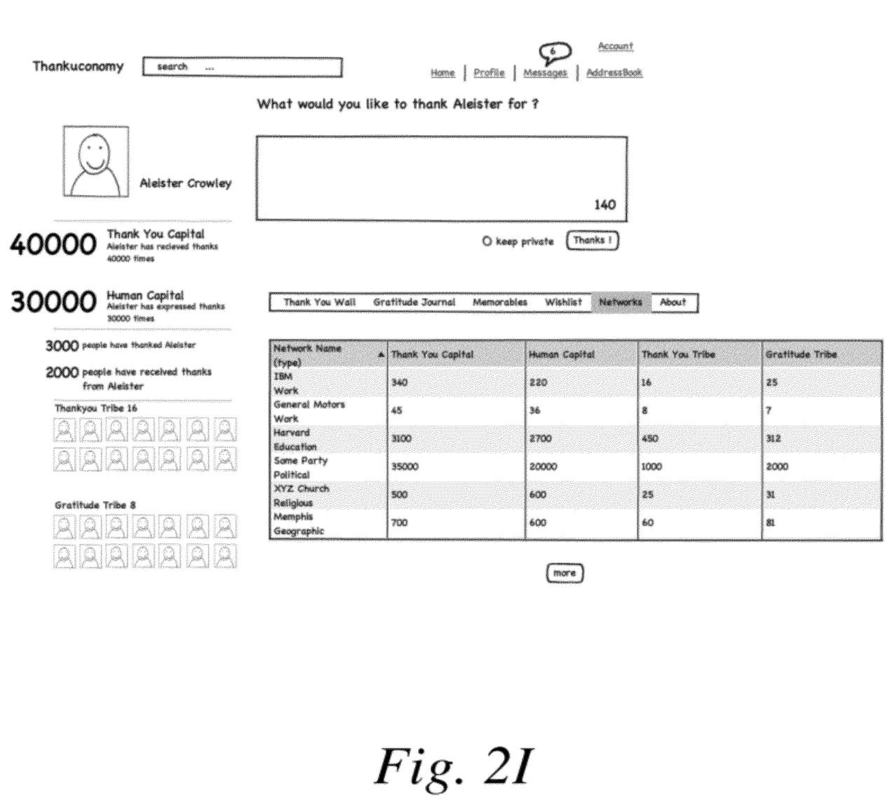

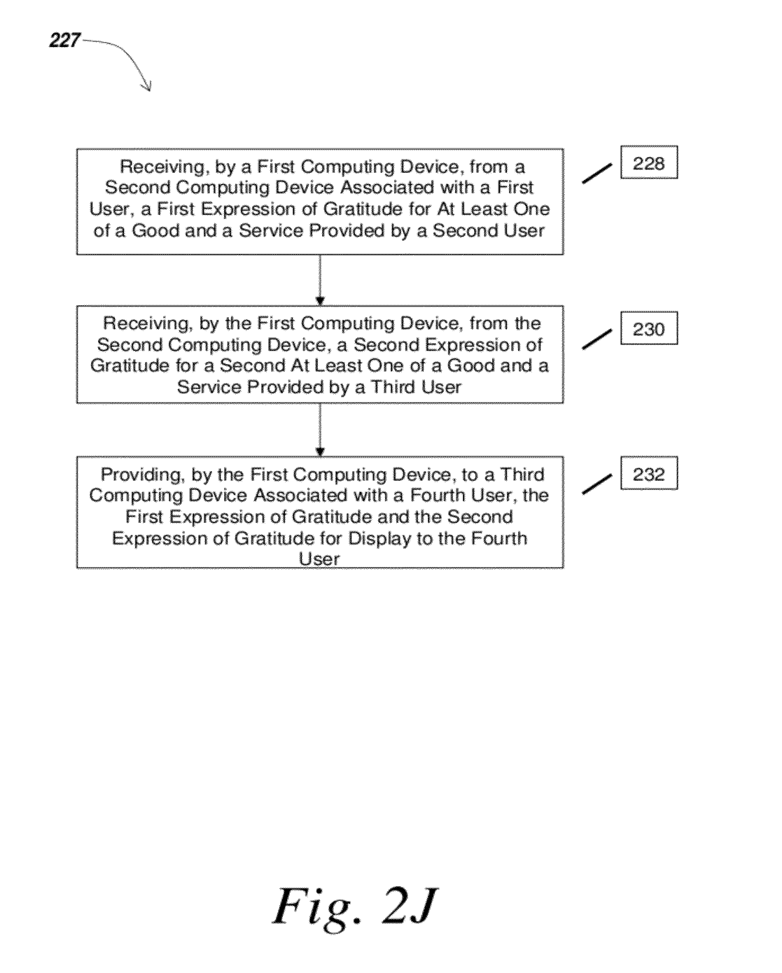

Referring now to FIG. 2A, a block diagram depicts an embodiment of system 200 for incentivizing, exchanging, and tracking expressions of gratitude. In brief overview, the system 200 includes a client 102a, a client 102b, a remote machine 106a, an expression generation engine 202, an expression history interface 204, an influence, impact, and trust calculation engine 206, a network visualization component 208, a gift exchange engine 210, and a reminder engine 212.

Referring still to FIG. 2A, and in greater detail, a client 102a accesses the remote machine 106a. In one embodiment, a user of the client 102a accesses user interfaces provided by components executing on the remote machine 106a to generate an expression of gratitude for a user of a client 102b. In another embodiment, the user of the client 102b accesses the remote machine 106a; for example, the user of the client 102b may access the remote machine 106a to view an expression of gratitude received from another user.

In one embodiment, the expression generation engine 202 provides functionality allowing users to express or receive thanks. There are various means, devices, and software components for expressing thanks, and registering an expression of gratitude with anetwork for exchanging such expressions.

In some embodiments, user devices for interacting with the system 200 may include physical devices, which may be referred to as hardware entry points. In one of these embodiments, the hardware entry points to the system include but are not limited to the following: mobile phones, servers, and computers (including mobile computing devices of any kind such as, without limitation, portable computing devices, personal digital assistants, palmtops, laptops, and tablet computers, cameras, printers, scanners, and television sets). In other embodiments, an entry point may include any device 100 described above in connection with FIGS. 1A-1C.

In some embodiments, the expression generation engine 202 includes a corporate expression component 214. In one of these embodiments, the corporate expression component 214 includes interfaces for use by professionals within an organization in exchanging expressions of gratitude with other members of the organization. In other embodiments, the expression generation engine 202 includes an expression importer 215. In one of these embodiments, the expression importer 215 is in communication with a second system, either on the remote machine 106a or on a second remote machine 106b, on which a user may have stored data including previously generated expressions of gratitude.

In some embodiments, a hardware entry point provides a user interface with which a user may interact with the system 200; such interfaces may be referred to as software entry points. In one of these embodiments, the software entry points to the system 200 include but are not limited to the following: software executing on the user device (such as, for example, dedicated client-side software), internet-based software (such as software from which a user may access the interface via a web browser), and data storage systems or databases.

In some embodiments, the expression generation engine 202 provides an interface through which a user may access the system for expressing thanks via a second system. In one of these embodiments, the interface may be referred to as an application entry point. In another of these embodiments, an application entry point to the system includes but is not limited to the following: an Application Programming Interfaces (APIs), a web-based or mobile-based social network (such as Facebook, Twitter, Yammer, LinkedIn, YouTube, Chatter), email, chat clients, widgets, or a reply to a GratitudeMinder (described in detail below).

Referring ahead to FIG. 2J, a flow diagram depicts one embodiment of a method 227 for providing, to one user, expressions of gratitude sent by a first user to a plurality of recipients. The method 227 includes receiving, by a first computing device, from a second computing device associated with a first user, a first expression of gratitude for at least one of a good and a service provided by a second user (228). The first computing device receives, from the second computing device, a second expression of gratitude for a second at least one of a good and a service provided by a third user (230). The first computing device provides to a third computing device associated with a fourth user, the first expression ofgratitude and the second expression of gratitude for display to the fourth user (232). In some embodiments, the first computing device is the remote machine 106a and the second and third computing devices are clients 102a.

In one embodiment, a user thanks another user by making an entry on another user's profile page using any of the available mediums, through any of the entry points to the system. In some embodiments, a profile page (also referred to as a profile) may include a listing of any of the following, without limitation: user's contact, work, education, interest, other background information, Thank You Wall (described in greater detail below in connection with FIG. 2H), Gratitude Journal (described in greater detail below in connection with FIG. 2G), wish lists identifying desired gifts, networks, memorable or favorite expressions of gratitude, gifts, recognition (such as awards), an identification of a level of influence, an identification of a level of impact, an identification of a level of trust, an identification of any communities to which the user belongs, and other system generated/user entered information. In other embodiments, a profile includes an interface through which viewers of the profile may send the user an expression of gratitude.

In some embodiments, users may indicate the recipient of an expression of gratitude in the text of the expression of gratitude by preceding the recipient's unique identifier (consisting of alphanumeric combinations) with @ (for example, @john-doe). In one of these embodiments, a unique identifier for the user consisting of alphanumeric combinations is referred to as a “Username.” In other embodiments, a user may indicate the recipient by preceding the recipient's username with any symbol causing the username to stand out from the text (for example, and without limitation, any alphanumeric character or textual symbol. In still other embodiments, no symbol is required to identify the recipient username within the text.

Referring to FIG. 2J, and in greater detail, the first computing device receives, from the second computing device associated with the first user, the first expression of gratitude for the at least one of the good and the service provided by a second user (228). In one embodiment, the expression generation engine 202 executing on the remote machine 106a receives, from the client 102a, the first expression of gratitude. In another embodiment, the expression generation engine 202 transmits the first expression of gratitude to the second client 102b for display to the second user. In still another embodiment, the first computing device transmits a gift to the second user with the first expression of gratitude. For example, the expression generation engine 202 may direct the gift exchange engine 210 to transmit the gift to the second user. In another example, the expression generation engine 202 may direct the gift exchange engine 210 to direct a third party machine 106b (not shown) to transmit the gift to the second user. In one embodiment, the gift exchange engine 210 includes an interface through which a user may purchase a gift for another user. For example, a first user may generate an expression of gratitude and send that “thank you” to a second user along with a gift selected and purchased via one or more interfaces provided by the gift exchange engine 210. In some embodiments in which users receive points for exchanging messages, the gift exchange engine 210 may include an interface through which the first user may use their own points, as opposed to currency, in acquiring the gift for the second user.

The first computing device receives, from the second computing device, a second expression of gratitude for a second at least one of a good and a service provided by a third user (230). In one embodiment, the expression generation engine 202 transmits the second expression of gratitude to a fourth client 102d. In another embodiment, the expression engine 202 transmits a gift and the second expression of gratitude to the third user. For example, the expression generation engine 202 may direct the gift exchange engine 210 to transmit the gift to the third user. In another example, the expression generation engine 202 may direct the gift exchange engine 210 to direct a third party machine 106b (not shown) to transmit the gift to the third user.

The first computing device provides to a third computing device associated with a fourth user, the first expression of gratitude and the second expression of gratitude for display to the fourth user (232). In one embodiment, the machine 106a displays the first user's previously transmitted expressions of gratitude to the third computing device 102c. For example, and in some embodiments, the first user may specify that the machine 106a should include copies of expressions of gratitude she sends to others on a profile or summary of her activity on the site that the machine 106a may share with other users. In one of these embodiments, the machine 106a includes a copy of the expression of gratitude. In another of these embodiments, the machine 106a includes a depiction of the expression of gratitude. In still another of these embodiments, the fourth user browses through profiles of a plurality of users of the site and when the fourth user selects the profile of the first user, the third computing device 102c receives, from the remote machine 106a, an enumeration of expressions of gratitude sent by the first user.

In one embodiment, the first computing device associates a plurality of expressions of gratitude with the second user. In another embodiment, the first computing device provides, to a fourth computing device associated with a fifth user, a subset of the plurality of expressions for display to the fifth user, the second user and the fifth user each identified in an enumeration of users in a community. By way of example, the second and fifth users may be in a community (e.g., a network, a tribe (described in additional detail below, or other plurality of users) together. In another example, a user in a community may specify that he only wants to see expressions of gratitude sent by other users in the community whenever he logs in to the system. In still another example, the user may specify that for a particular interaction with the system, he only wants to see expressions sent by others in the community—for example, when using a filter to focus in on expressions exchanged by fellow members of the community.

In some embodiments, communities are groups of users. In other embodiments, communities are groups of users that have each received an expression of gratitude from a common user. In further embodiments, communities are groups of users that have each sent an expression of gratitude to a common user. In still other embodiments, communities are groups of users that have a goal in common. In one of these embodiments, the group of users forms a community when they work together towards the accomplishment of a goal. In another of these embodiments, a goal-oriented community is referred to as a “project.”

In some embodiments, and as described above, a community, or other collection of individuals related by some religious, social, political, professional, geographic, educational, or other affiliation, may be referred to as a network; these affiliations can also pertain to shared interests, goals, or other user-defined criteria. In one embodiment, individuals within a network may or may not be part of each other's sub-networks. In another embodiment, a user may be a part of multiple networks.

In some embodiments, a user can confirm membership to a network by using a method for confirming user identity. In one of these embodiments, membership can be confirmed if one or more users already in the network confirm that a given user is a member of the specified network. In another of these embodiments, a first user sends a message requesting confirmation of membership to a second user that is already part of the network. In still another of these embodiments, if the second user confirms that the first user is a member of the network, then the first user is added to the network.

In other embodiments, a user can also confirm membership to some networks such as educational and professional networks by adding and verifying an email address ending with @network_identifier; for example, a user may sign up using an email address ending with “microsoft.com”, an email is sent to the specified email, the user clicks on a link to confirm that the user owns the specified email address, and, as a result, the user is added by the Thank You Network to the Microsoft Network. In further embodiments, a user acquires membership to some network types within the Thank You Network without any verification. For example, in one of these embodiments, a user may not be required to provide any proof that the user is a resident of a particular geographic location.

In one embodiment, a third party site, network, service or application may send the login credentials for a user to the Thank You Network in an attempt to verify the identity of the user wanting to use their service. If the login credentials provided by the third party are valid, a response is sent saying the user's identity has been authenticated. Otherwise, an invalid credentials response is sent.

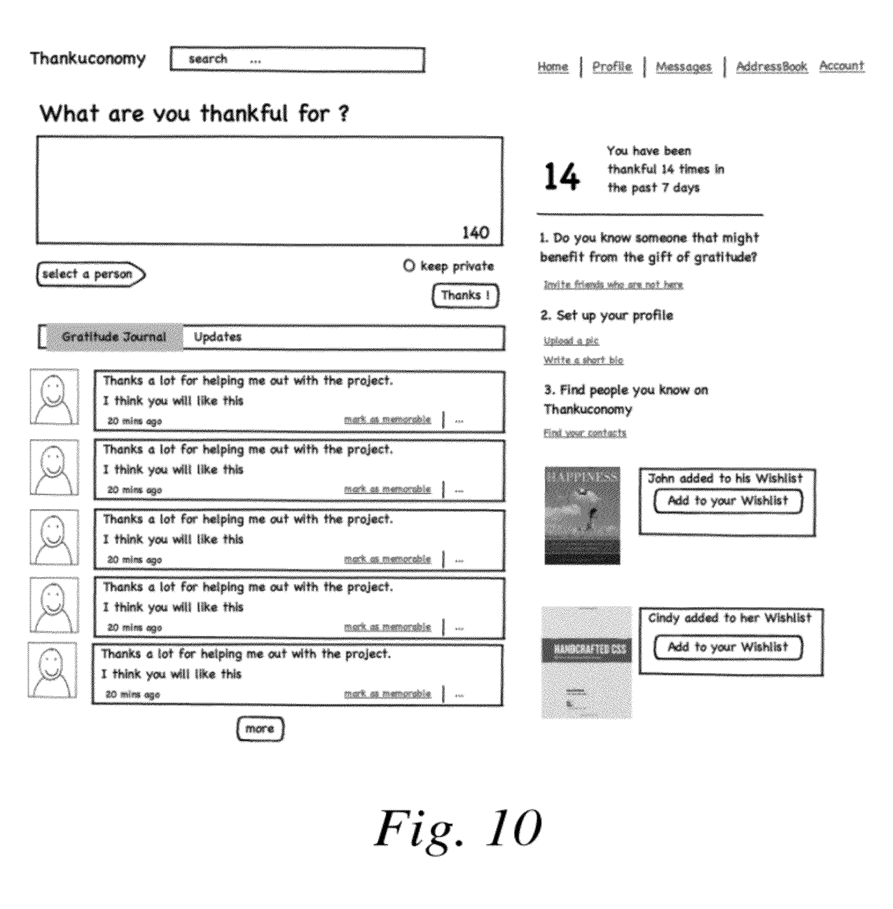

In one embodiment, the first computing device transmits to the second computing device, a recommendation for at least one of the first user and the fourth user, based upon a characteristic of the second user. In another embodiment, the first computing device transmits to the second computing device, a recommendation for at least one of the first user and the second user, based upon a type of the expression of gratitude. In some embodiments, based on who thanked whom, different recommendations may be made to users of the system. In one of these embodiments, by way of example, if a first user thanks a second user for performing a particular service, a third user searching for users to perform that service may receive a recommendation to contact the second user. In another of these embodiments, by way of example, if the second user has identified areas of interest (for example, hobbies, recent purchases, and recent activities) and the system determines that the second user is particularly influential on a group of other users (based on, as will be described in further detail below, a number of expressions of gratitude sent or the type of person sending the expression of gratitude or the type of expression of gratitude), the system may send to individuals in the group of other users recommendations based on the second user (e.g., without limitation to buy books the second user bought, eat at restaurants, and participate in an activity). In some embodiments, based on who thanked whom and membership in particular communities (including networks), different recommendations maybe made to users of the system. In other embodiments, based on who thanked whom, different recommendations maybe made to users of the system who also use a third party system; the recommendations may be displayed by the third party systems. In further embodiments, recommendations may be made for actions such as, without limitations, purchase or use a good or a service, visit a place, use a particular business or object, hire an individual, promote an individual, partner with a user (which may include individuals, organizations), and modify a compensation level of a user. Recommendations are described in additional detail in connection with FIG. 10 below.

In one embodiment, the first computing device identifies a type of the expression of gratitude. In another embodiment, the first computing device receives an identification of a type of the expression of gratitude. As will be discussed in further detail below, the remote machine 106a may generate, or receive from users, identifications of types of expressions, which may be referred to as topics; topics may include without limitation the formats of the expressions.

By way of example, and without limitation, expressions of gratitude can be sent in any of the following formats using any of the above entry points: text, video, short message service, multi-media service, drawings, scanned documents, photographs, or other digital media. The following illustrative examples show how the methods described above may be implemented to express gratitude in a system as described above. These examples are meant to illustrate but not limit the disclosure.

In one embodiment, a first user submits an expression of gratitude using an application running on his mobile device 102; the expression of gratitude (or “Thank You”) is added to the recipient's profile on the Thank You Network and the recipient receives a notification of the addition. In another embodiment, the recipient sends a message to the sender by logging in to the Thank You Network via a browser on her laptop device 102. While the recipient is on the website, she decides to upload a video on YouTube and send the link as a Thank You to a third user of the Thank You Network. In still another embodiment, the recipient also remembers that she made a few hand-made Thank You cards that she scans through a scanner on her multi-function printer, selects the recipients, and presses a button to wirelessly upload the scans as Thank Yous directly to the Thank You Network's servers from the printer; the scanned cards are posted as Thank Yous to the recipient's profile on the Thank You Network. In yet another embodiment, after completing a few scans, the recipient remembers that she can send Thank Yous to the Thank You Network by taking pictures through her phone camera as well; the recipient sends pictures of the rest of the hand-made Thank You cards from an application executing on her camera phone 102.

Referring again to FIG. 2A, the expression generation engine 202 may include a reminder engine 212. In one embodiment, the reminder engine 212 may be referred to as a “Gratitude Minder” 212. In some embodiments, the gratitude minder 212 provides functionality for selecting and transmitting a previously sent expression of gratitude. In one of these embodiments, the gratitude minder 212 selects a previously transmitted expression of gratitude at random. In another of these embodiments, the gratitude minder 212 generates a message to the user that generated the randomly selected, previously transmitted expression of gratitude reminding the user that he or she previously expressed gratitude to another user. In still another of these embodiments, the gratitude minder 212 transmits the generated message and the randomly selected, previously transmitted expression of gratitude to the user. In other embodiments, a user receiving a message from a gratitude minder 212 may receive a reminder to transmit a new expression of gratitude to another user.

In one embodiment, the expression history interface 204 provides functionality for viewing previously sent or received expressions of gratitude. In another embodiment, the expression history interface 204 provides an interface through which a user of the system may identify a previously sent or received expression of gratitude as a favorite expression. The user may specify a higher level of importance in retaining such an expression. The user may designate the expression as one that is to be displayed in a prominent location on user interfaces generated by the system for that user. In some embodiments, a previously sent or received expression of gratitude that a user has designated as having a higher level of importance to the user than another expression of gratitude is referred to as a memorable expression. In other embodiments in which the system includes functionality for calculating a level of influence, impact, or trust for a user (as will be discussed in greater detail below) a memorable expression may contribute to calculation of a higher level.

In one embodiment, the network visualization component 208 includes an interface allowing a user to visualize his or her relationships with other users of the system. In some embodiments, the network visualization component 208 provides functionality allowing a user to view or analyze points received for sending or receiving an expression of gratitude.

In one embodiment, the influence, impact and trust calculation engine 206 includes an interface displaying to a user a ranking of one or more users based on a number of expressions of gratitude exchanged.

Referring now to FIG. 2B, a network diagram depicts one embodiment of a Thank You Network in communication with a variety of social networks, where data available on the Thank You Network can be displayed on various networks (including social networks) and vice versa.

In some embodiments, the system 200 includes functionality allowing a user to maintain contact information for other users or other persons, entities, or organizations that may not be users but who are eligible to become users. In one embodiment, persons, entities or organization that are not users but who are eligible to become users are referred to as “non-users.” In some embodiments, a means of contact such as a name, email or phone number is available for a non-user. This functionality may be referred to as an address book (not shown). In one embodiment, an address book includes at least one contact that a particular user has saved in the Thank You Network or marked to remember (contacts may be users or non-users). A user may add contacts to the address book using a network connection to another contacts service, uploading a file from a computer, importing contact information from email or another social network service such as Facebook. A user may also click on the “Add to Address Book” (or equivalent) button on another user's profile to add that user to his/her address book. If a given contact in the address book is a member of the ThankYou network, a visual indication along with a link to the profile might be provided. In some embodiments, users in the address book may show up earlier in search queries for a person on the Thank You Network.

Referring now to FIG. 2C, a block diagram depicts one embodiment of a user's profile screen. As depicted in FIG. 2C, the profile screen includes one or more user interface elements. In one embodiment, and as shown in FIG. 2C, when a user selects a tab labeled, for example, “about”, the system displays interfaces for adding another user (e.g., Aleister) to the first user's address book and subscribing to updates from another user. In another embodiment, the system may display information about the location of a user and about some or all of a user's networks, such as professional networks and academic networks. As depicted in FIG. 2C, a listing on a user's profile may display topics, ideas, or subjects in which the user is interested; clicking on any of the listed interests may provide options to select gifts and view relevant information such as news related to the interest. By way of example, interests may be displayed in an “About” section for the user, or in a separate section.

As shown in FIG. 2C, in some embodiments, users may elect to receive at least some updates of activity from another entity (such as, without limitation a user, a community, a topic, or other user-defined entity). Such updates can include expressions of gratitude sent or received by another user, or expressions of gratitude related to a particular topic. In one embodiment, a user may view all such updates through an update screen, and can filter such updates by users, communities, networks, topics, as well as activity type. For example, a manager in a company might subscribe to Thank You updates for all his employees that are received from other users within the company's network. In one embodiment, the term “update” refers to a listing of all/all new/all relevant Thank You(s) sent by other users of the Thank You Network. In one embodiment, a user subscribes to receive these updates. In another embodiment, a user may select an option to automatically subscribe to updates from users based on certain criteria, such as, without limitation, a member of a network to which the user belongs, or, by way of example, any member of the user's current company network. In some embodiments, a system includes a component such as an update engine 222 depicted in FIG. 2A to provide this functionality.

Referring now to FIG. 2D, a block diagram depicts one embodiment of a system for displaying Thank You(s) along with contact information for a person calling a user on a mobile device of the user, including a display of a Thank You given by the user to the person calling the user, retrieved from the Thank You Network and displayed on the phone next to other information about that person.

In some embodiments, a randomly selected expression of gratitude that was received or given by User, A, to another User, B, is displayed next to User B's contact information in User A's address book on the Thank You Network or on other services where Thank You Network information is made available, such as on a phone or a third party site. In another embodiment, User A may assign a particular Thank You to be displayed. For example, and as shown in FIG. 2D, User A may specify that when she receives a phone call from User B, User B's name and other information along with a Thank You given to User B by User A is displayed.

In one embodiment, widgets are user interface elements (e.g., abutton, a panel, a text-based link, an image, or other interface element) displayed by users or by third party goods or services and that contain a user's profile information. In another embodiment, this information is updated regularly as the user's profile is updated on the Thank You Network. In some embodiments, a widget includes a user interface for other users or non-users to submit an expression of gratitude to a particular user for whom the widget has been displayed. In one of these embodiments, the expression of gratitude is automatically sent to the user for whom the widget has been displayed. In another of these embodiments, the expression of gratitude is added to the user's profile. In still another of these embodiments, the user interacting with the widget need not enter any text for the widget to generate and send the expression of gratitude to the user for whom the widget has been displayed. For example, and as shown in FIG. 2E, a blog's author may display such a widget on his site to show the expressions of gratitude received from the site's readers and enable readers to leave expressions of gratitude for the author.

Referring again to FIG. 2E, a block diagram depicts one embodiment of a system for displaying widgets on a third party service. In one embodiment, expressions of gratitude or data associated with a user of a thank you network may be displayed in a third party service, such as a blog, media store, email system, or other social network (e.g., an Apple Store, Outlook/Gmail, or Facebook). In one embodiment, the displayed data includes, without limitation, a display of Thank You Network information such as an indication of a level of influence, an indication of a level of trust, an indication of a level of impact, an identification of one or more communities to which the user belongs, and randomly selected expressions of gratitude received. In another embodiment, the displayed data is associated with a user who is also an author of the blog or other third party service. In still another embodiment, the displayed data is shown in a widget on a blog site with a display of an interface for giving the author of the blog an expression of gratitude. In some embodiments, the third party service embeds not only a display of user data or exchanged Thank Yous but also the entirety of the Thank You Network within the third party service. In other embodiments, the third party service embeds not only a display of user data or exchanged Thank Yous but also a private installation of a Thank You Network.

Referring now to FIG. 2F, a block diagram depicts one embodiment of a home page screen for a new user. In one embodiment, the screen includes a user interface element for entering an expression of gratitude. In another embodiment, the screen includes a user interface allowing the user to select a recipient. In still another embodiment, the screen includes a display of suggested first actions for a new user to take.

Referring now to FIG. 2G, a block diagram depicts another embodiment of a home page screen. In one embodiment, the screen includes a listing of the expressions of gratitude that a user has expressed, an option to view updates (which is not selected in the embodiment displayed in FIG. 2G), an identifier of a number of new messages, an option to a mark a Thank You as “memorable” displayed next to each expression of gratitude, and an example of one of the many metrics calculated in the Thank You Network showing that the User has given 14 expressions of gratitude in the past 7 days. In one embodiment, a listing of all the Thank You(s) that a user has expressed is referred to as a “Gratitude Journal.” One of the locations where this listing may be displayed is on the user's profile.

Referring now to FIG. 2H, a block diagram depicts another embodiment of a user's profile screen. In this embodiment, the tab for the listing of all the expressions of gratitude that a user has received is selected. In one embodiment the listing of all the expressions of gratitude that a user has received is referred to as a “Thank You Wall.” The Thank You Wall tab displays user interfaces displaying information about the user such as, without limitation, an indication of a level of trust, an indication of a level of impact, an indication of a level of influence, an indication of one or more communities to which the user belongs, an option to give the user an expression of gratitude, and a listing of some of the expressions of gratitude received by the user under the selected tab of Thank You Wall.

Referring now to FIG. 2I, a block diagram depicts another embodiment of a user's profile screen. In this embodiment, the networks tab is selected and displays a table listing the networks that the user belongs to as well as indications of the user's levels of impact, influence or trust in each of those networks.

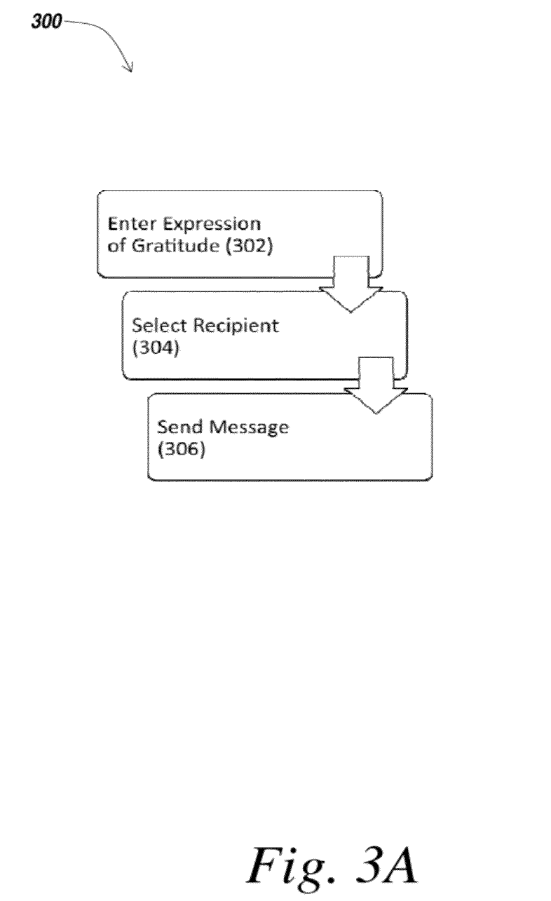

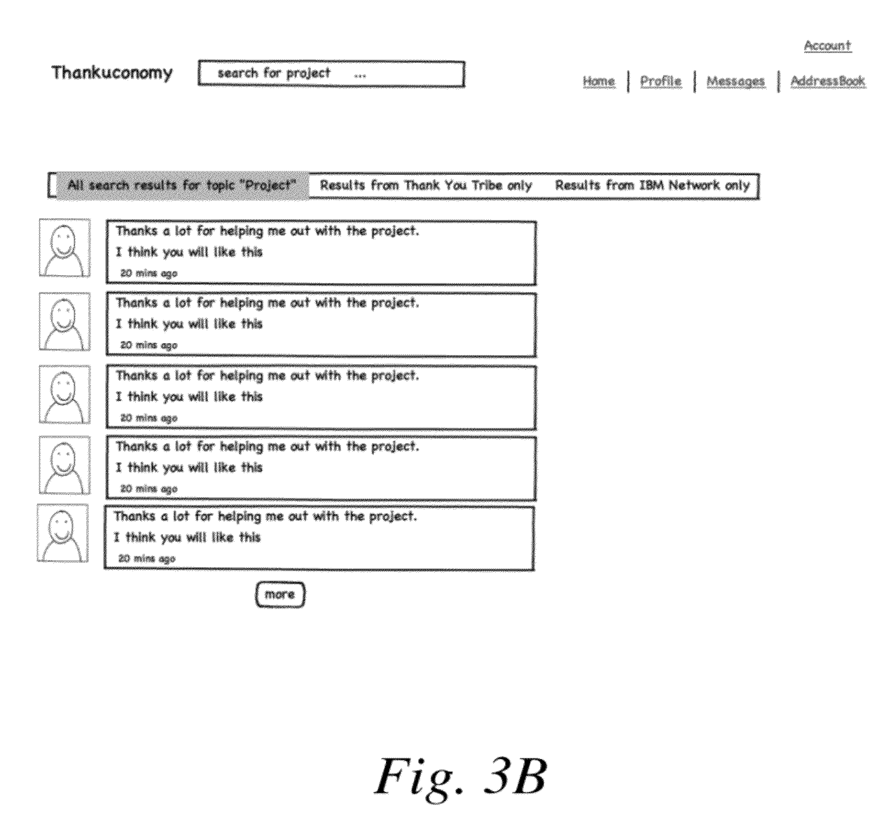

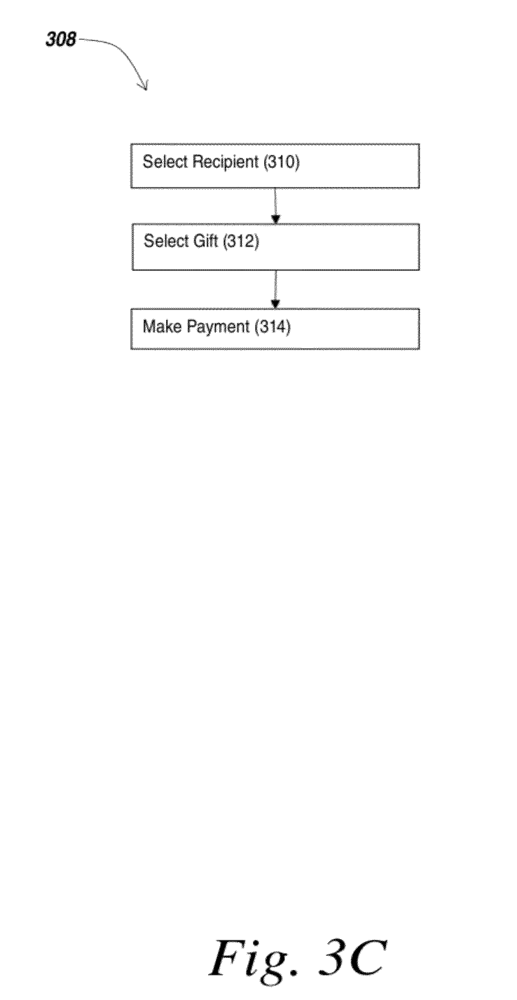

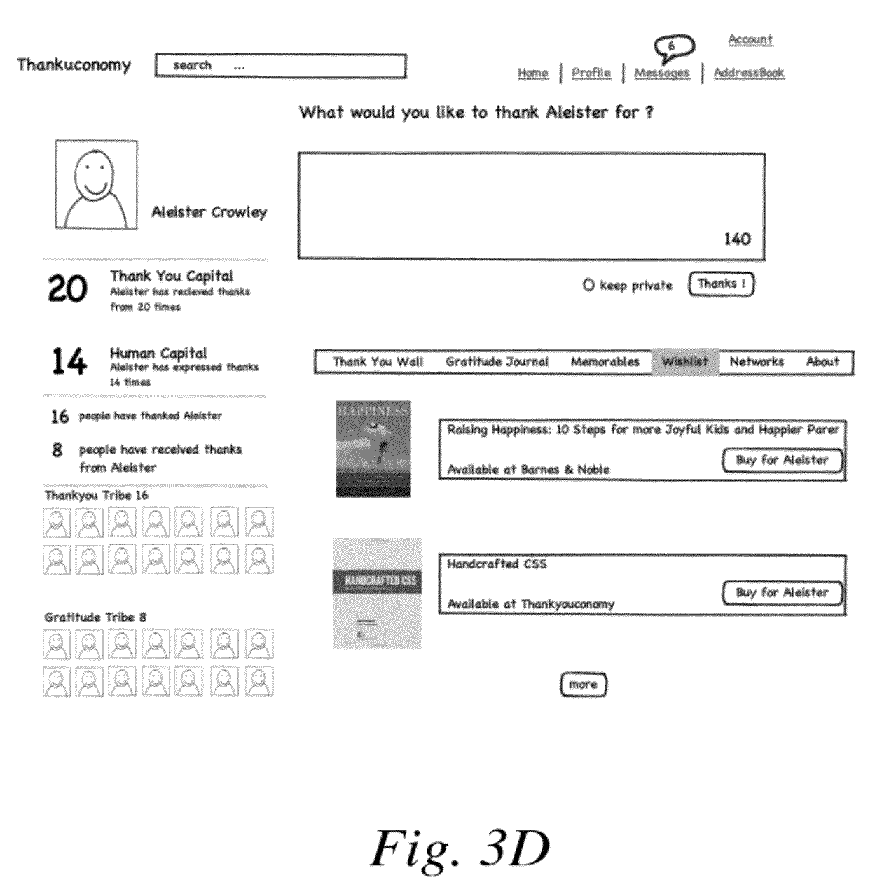

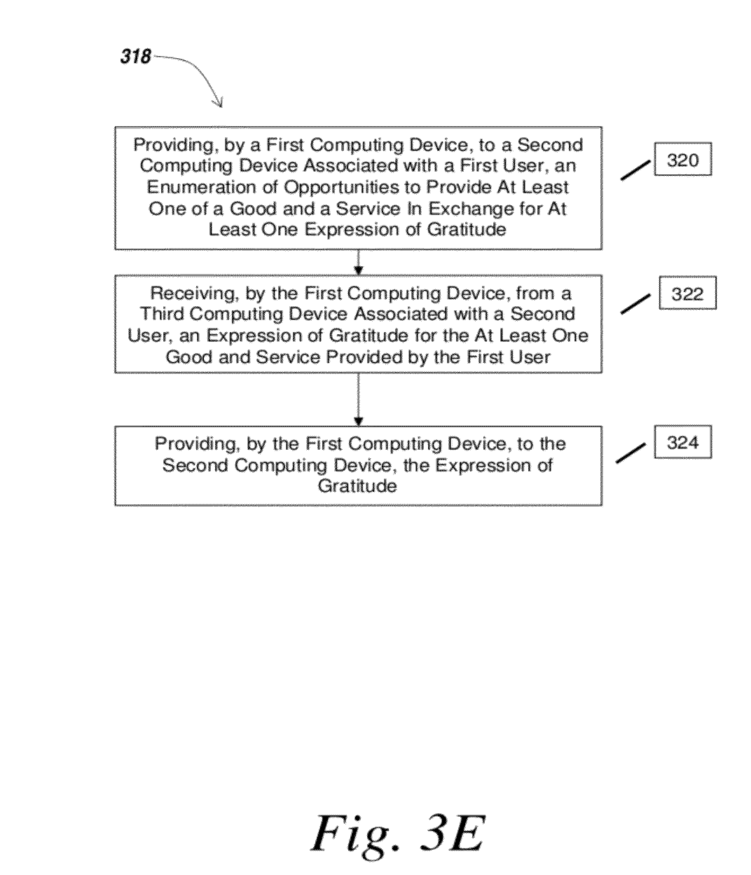

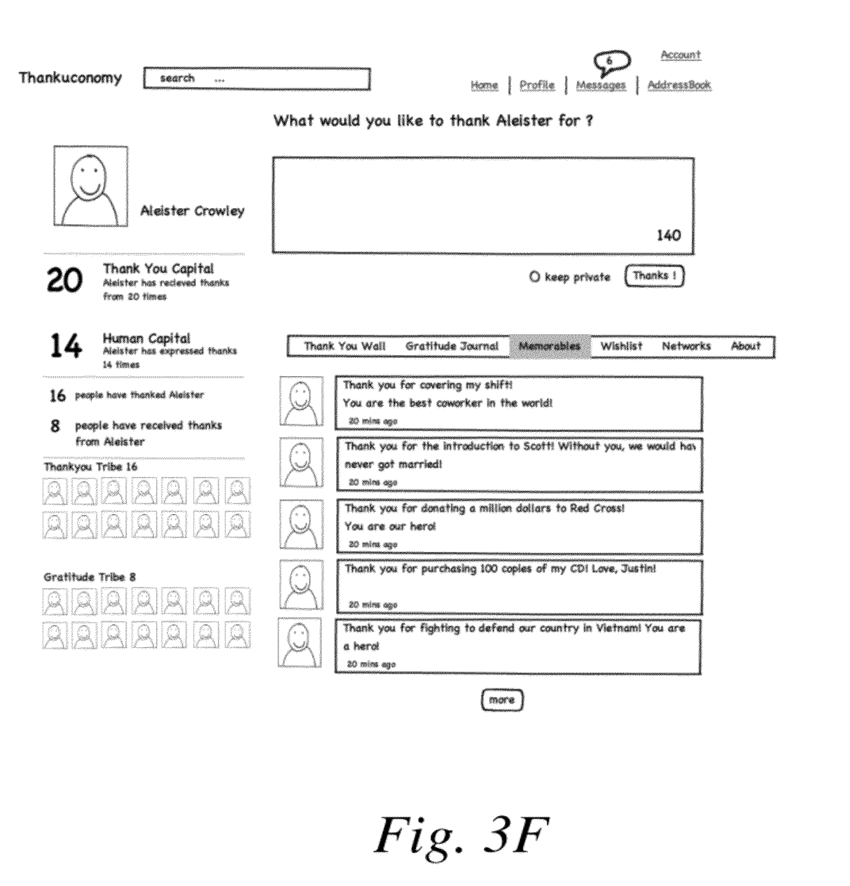

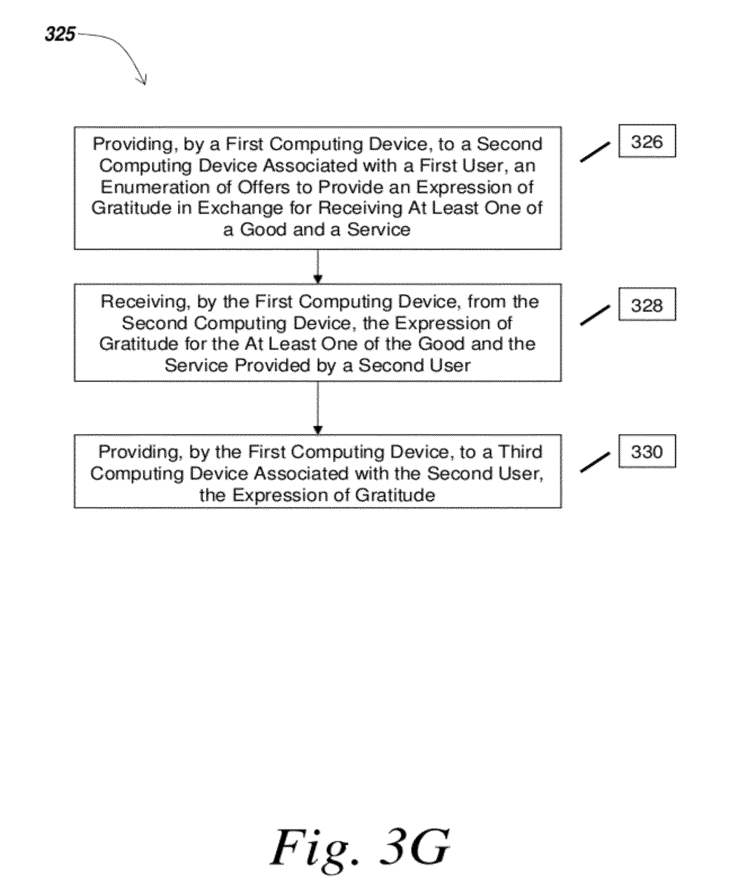

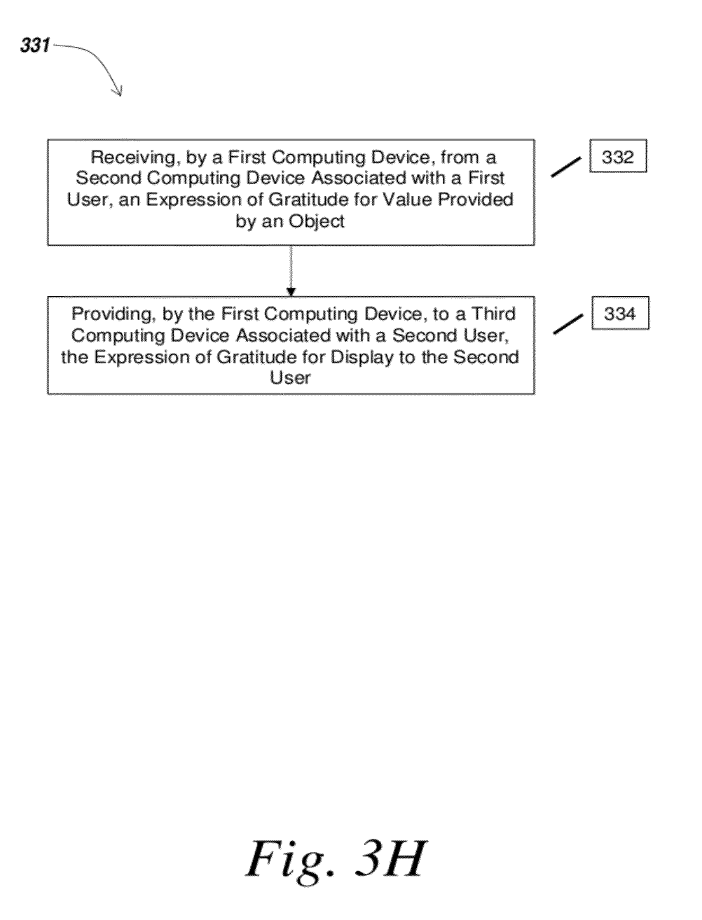

Referring now to FIG. 3A, a flow diagram depicts one embodiment of a method 300 for generating and transmitting an expression of gratitude. In brief overview, the method 300 includes entering a thank you message into a system interface (302). The method 300 includes selecting a recipient for the message (304). The method 300 includes transmitting the message to the recipient (306). In some embodiments, the method 300 includes identifying a gift for acquisition and transmission to the recipient of the expression of gratitude. In other embodiments, the method 300 includes generating a description of a relationship between the user sending the thank you message and the user receiving the thank you message.

An expression of gratitude that a first user gives to a second user may contain terms that describe the reason for which the expression of gratitude is being given. In one embodiment, and as described above in connection with FIG. 2J, such a descriptive term (typically a word that can be used to categorize expressions of gratitude) is referred to as a “topic.” A user may choose to thank another user for a particular topic. For example, a user may thank another user for helping him with a voiceover for his commercial. Voiceover and commercial are two potential topics in this example. In another embodiment of this method, the user may use a hash tag (#), other alphanumeric symbol, or other identifier, to indicate that a particular term in the content of the expression of gratitude is a topic. Alternatively, topics can be created automatically by indexing the content of the expressions of gratitude using a topic engine when an expression of gratitude is created or when the expression of gratitude is sent. Topics may also be separately specified and associated with an expression of gratitude. In other embodiments, tags or keywords may be associated with a particular expression of gratitude. Such keywords, topics, or tags may be searched as will be described in connection with FIG. 3B.

Referring now to FIG. 3B, after an association between an expression of gratitude and a topic has been created, users can search for expressions of gratitude by topic. For example, a user may search for all expressions of gratitude that contain the topic ‘commercial’ either throughout the entire Thank You Network or filtered for a more targeted search, such as filtered to show only results within a community to which the user belongs. In one embodiment, expressions of gratitude containing that topic are displayed in a relevant order. Relevance may be determined by criteria such as total number of expressions of gratitude a user has received on that particular topic or whether the expression of gratitude was given or received to a person in the community of the user that searched for the topic. A user can also search for expressions of gratitude by topic within a group of networks or within a specific network. In addition to providing interfaces for searching for expressions of gratitude, the method may include providing an interface with which a user can search for other users.

In some embodiments, when an expression of gratitude includes a certain amount of text (e.g., without limitation, when text is longer than 140 characters), it may be presented on a separate page. In one of these embodiments, listings of expressions of gratitude, such as the Thank You Wall and Gratitude Journal, may display truncated versions of expressions of gratitude and display a link to a page containing the full message. In other embodiments, a user may specify a number of characters above which a message is displayed on a separate page.

In one embodiment, a physical, digital, or virtual good or service that is provided to another user is considered a gift. In another embodiment, gifts are given along with a Thank You, or in return for a Thank You. In still another embodiment, a gift may or may not be an item listed on the gift recipient's wish list.

In one embodiment, a gift may include money. In another embodiment, by way of example, a gift may be a promise to provide a good or service in the future. In some embodiments, a gift may be in the form of a discount on future services/goods, or other incentives. As an accompaniment to an expression of gratitude, in other embodiments, users may offer services or discounts on future services and goods. In other embodiments, a user may give or receive payment from another user for an expression of gratitude.

In some embodiments, and as shown above in FIG. 3A, a user may be presented with the option to select a gift as one of the steps when sending an expression of gratitude. In one of these embodiments, a user may also browse the gift catalog on the Thank You Network to select a gift, or attach a gift purchased from another website to an expression of gratitude; users can be charged for purchasing a gift.

In some embodiments, a virtual gift includes an asset that may be displayed on a user's profile and may contribute to a user's level of trust (discussed in additional detail below). A digital gift includes items such as, without limitation, a digital version of a book, a song, and a greeting card. A description of the gift can optionally be included in the expression of gratitude posted on the recipient's profile.

In one embodiment, one user can give another user a “Gift of Trust” which may increase a level of trust associated with the receiving user; this increase would be applied to a level of trust calculated as a result of receiving an expression of gratitude. In another embodiment, a “Gift of Trust” is a special category of a virtual gift.

In some embodiments, users can purchase physical goods including but not limited to gift cards, greetings cards, Thank You Wall Posters (i.e., a print out of some or all of the Thank You(s) that a user has received, printed on a large poster), a Journal of Gratitude (a print out of all or a selection of Thanks Yous that a user have given to other Users), and a listing of expressions of gratitude exchanged between particular two users. In one embodiment a listing of expressions of gratitude exchanged between two users is referred to as a “Thank You Versation Journal.”

FIG. 3C depicts one embodiment of a method 308 in which a user generates and transmits an expression of gratitude with a gift. The user selects a recipient (310). The user selects a gift (312). In one embodiment, the user is presented with a screen to type a message to include with the gift. The user makes a payment (314). The user may purchase the item for himself or send it as a gift to another user with an expression of gratitude. If sending a physical good, a user may elect to delay the delivery of the expression of gratitude within the Thank You Network until the physical good is delivered.

Referring now to FIG. 3D, a block diagram depicts one embodiment of a user's profile including a wish list interface. In one embodiment, when a wish list tab is selected, an interface displays one or more items desired by the user. In another embodiment, and by way of example, two books are listed under the user's wish list, with metadata information such as where to buy the books, and an option for the user viewing the page to buy them for the user profiled in the page (e.g., Aleister in FIG. 3D). In still another embodiment, a wish list is a list of products, gifts, requests, and experiences that a user desires that is part of a user's profile on the Thank You Network. In yet another embodiment, a user can gift another user an item from that User's Wish list.

As shown in FIG. 3D, a user that wishes to purchase the item is either i) presented with a screen to purchase the item directly from the Thank You network or, ii) redirected to another site that sells the item. Not all items on the Wish list necessarily require a purchase; some items may involve non-monetary requests.

Examples of the methods by which a user can add items to their wish list include, without limitation: (i) a user can visit a wish list section on their profile and clicking the button to add an item; (ii) a user can click a button displayed in their browser to automatically send a uniform resource locator (URL) to be listed under their wish list; (iii) a user can take a photograph of an item they want and select an option through their picture-taking device (e.g., a phone with a camera, a stand-alone camera, and a computer with a camera) and upload the picture to their wish list (e.g., information about the contents of the picture may be provided by the picture-taking device, or determined by the Thank You Network servers); and (iv) a user can take a photograph of a bar code, QRCode, or other coding system for products and have that information sent to the Thank You Network server.

In one embodiment, a method for sending a collection of individual Thank You(s) to a user as a single unit is provided. In another embodiment, a collection of individual Thank You(s) delivered to the recipient at the same time is referred to as a “Bundle of Thanks.” In still another embodiment, a sender initiates a Bundle of Thanks request. In another embodiment, the sender is then provided the option to invite other Users to add their Thank You to the Bundle of Thanks request; invited users are sent a message to contribute their Thank You to a Bundle of Thanks. In yet another embodiment, when all invited users have added their Thank You(s) or declined the request to add a Thank You, a Bundle of Thanks is sent to the recipient; this may be displayed on the recipient's profile.

As part of the Bundle of Thanks, users can contribute a sum of money, or include a gift (as described above) or include a wish list item (as described above) to be sent to the recipient as part of the Bundle of Thanks. If money is being collected, instead of sending money directly to the recipient, the creator of the Bundle of Thanks request can choose to purchase Gifts or Wish list items for the recipient instead.

In some embodiments, a visualization or compilation of relationship information may be licensed to external parties. In one of these embodiments, a party external to the Thank You Network may pay for access to relationship data. In other embodiments, a party external to the Thank You Network may pay to avoid limits to rates of data access. In still other embodiments, individual users may pay to avoid limits to access. In one of these embodiments, the first computing device determines whether to reject the first expression of gratitude, based upon a limitation on a number of expressions a user is authorize to send. In still other embodiments, services relating to customer relationship management, advertising, and marketing may each benefit from access to this data. In yet other embodiments, services relating to employment or service recommendations may benefit from access to this data.

Referring to FIG. 3E, a flow diagram depicts an embodiment of a method 318 for providing an expression of gratitude. The method 318 includes providing, by a first computing device, to a second computing device associated with a first user, an enumeration of opportunities to provide at least one of a good and a service in exchange for at least one expression of gratitude (320). The first computing device receives, from a third computing device associated with a second user, an expression of gratitude for the at least one of the good and the service provided by the first user (322). The first computing device provides, to the second computing device, a first expression of gratitude (324). In still other embodiments, an expression of gratitude may be automatically posted upon completion of the service.

Referring to FIG. 3E in additional detail, the machine 106a provides, to the client 102a, the enumeration of opportunities to provide at least one of a good and a service in exchange for at least one expression of gratitude (320). In one embodiment, the system 200 provides an interface with which users may post opportunities for each other. In some embodiments, a user may offer services through a user profile in exchange for an expression of gratitude. In one of these embodiments, upon completion of those services, the recipient user posts a Thank You to the provider's profile.

The first computing device receives, from a third computing device associated with a second user, an expression of gratitude for the at least one of the good and the service provided by the first user (322). In one embodiment, the machine 106a receives the expression of gratitude as described above in connection with FIGS. 2A-J. The first computing device provides, to the second computing device, a first expression of gratitude (324). In some embodiments, the machine 106a hosts a separate page listing the services offered.

In one embodiment, a user provides a gift, goods, or services in exchange for a Thank You from another user. Alternatively, the user giving the Thank You might require the recipient to make a payment or complete certain actions in order to receive the Thank You. In some embodiments, in which users receive points for sending or receiving expressions of gratitude, a user may exchange accumulated points to provide a gift, goods, or services to another user or to himself.

By way of example, and referring now to FIG. 3F, an artist (in this example, Justin Bieber) is promoting his latest album and promises to thank any user who purchases 10 copies of his latest music album. Continuing with this example, a teenage user purchases 100 copies of the album, either by visiting his profile or following a link to another site that sells his album; in return for the purchase, Justin Bieber posts a video saying Thank You to her and her friends on her profile. In one embodiment, an option to accept requests for paid expressions of gratitude is enabled by both users prior to initiation; this option can also be time constrained by a user. For example, Justin Bieber may open this offer only for the first week after his album's release. FIG. 3F also depicts an example of a Memorable Thank You (because to the fan, the expression of gratitude received from Justin is memorable). In another example, non-profit organizations may automatically/manually post expressions of gratitude to a donor's profile when the donor contributes money or volunteers time at the non-profit.

Referring now to FIG. 3G, a flow diagram depicts one embodiment of a method 325 for providing an expression of gratitude in which the user offers to provide the expression of gratitude in exchange for at least one of a good and a service. The method 325 includes providing, by a first computing device, to a second computing device associated with a first user, an enumeration of offers to provide an expression of gratitude in exchange for receiving at least one of a good and a service (326). The first computing device receives, from the second computing device, the expression of gratitude for the at least one of the good and the service provided by a second user (328). The first computing device provides, to a third computing device, associated with the second user, the expression of gratitude (330).

Referring now to FIG. 3H, and in greater detail, a first computing device provides, to a second computing device associated with a first user, an enumeration of offers to provide an expression of gratitude in exchange for receiving at least one of a good and a service (326). In one embodiment, the machine 106a provides, to the second computing device, an interface with which the first user may view and interact with the enumeration of offers. In another embodiment, the machine 106a provides the enumeration as described above in connection with FIG. 3E. The first computing device receives, from the second computing device, the expression of gratitude for the at least one of the good and the service provided by a second user (328). In one embodiment, the machine 106a receives the expression of gratitude as described above in connection with FIGS. 2A-J. The first computing device provides, to a third computing device, associated with the second user, the expression of gratitude (330).

In one embodiment, the first computing device adds an identification of the first user to an enumeration of users associated with the second user. In another embodiment, the first computing device adds an identification of the second user to an enumeration of users associated with the first user. In some embodiments, by adding an identification of a user to an enumeration of users associated with a particular user, the machine 106a creates a community of users associated with the particular user—for example, a community of people who have thanked the user or a community of people who have received thanks from the user.

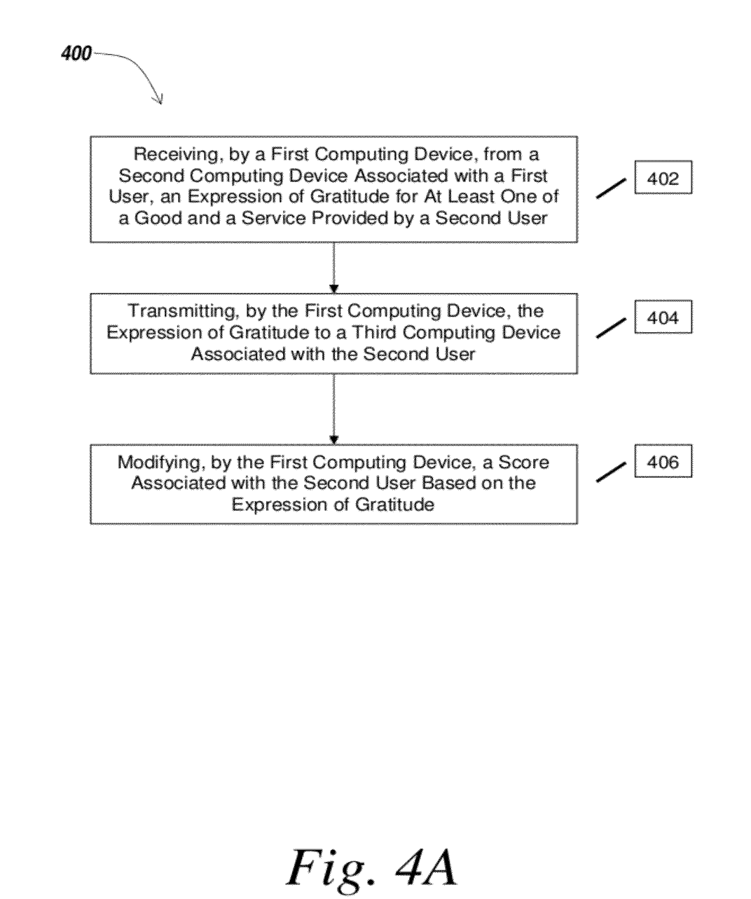

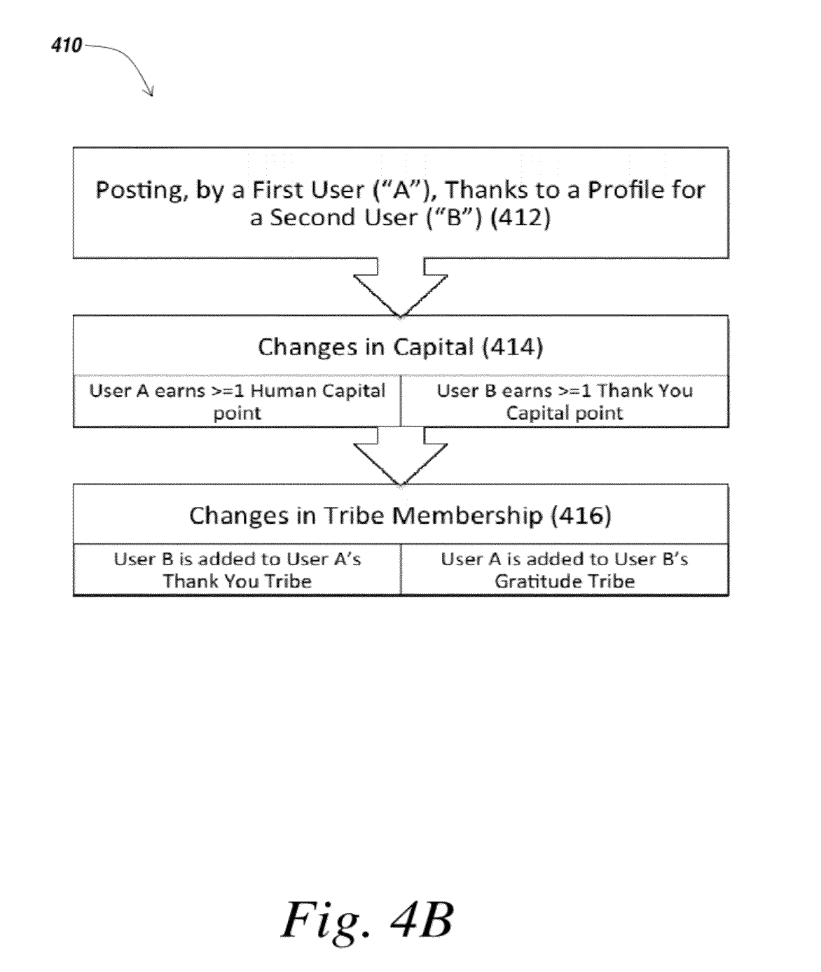

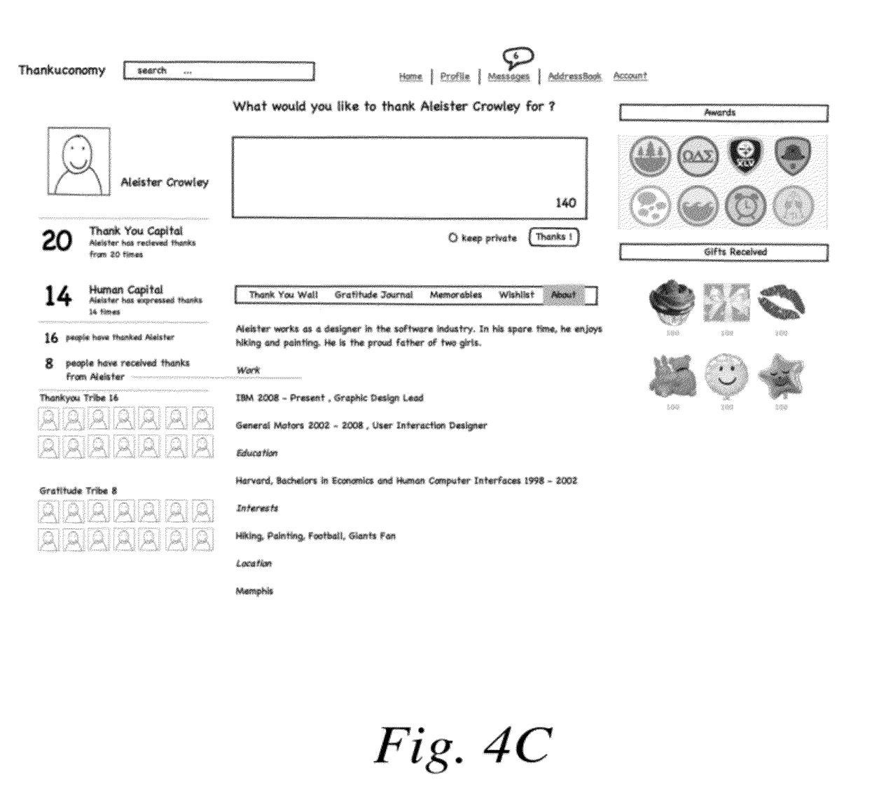

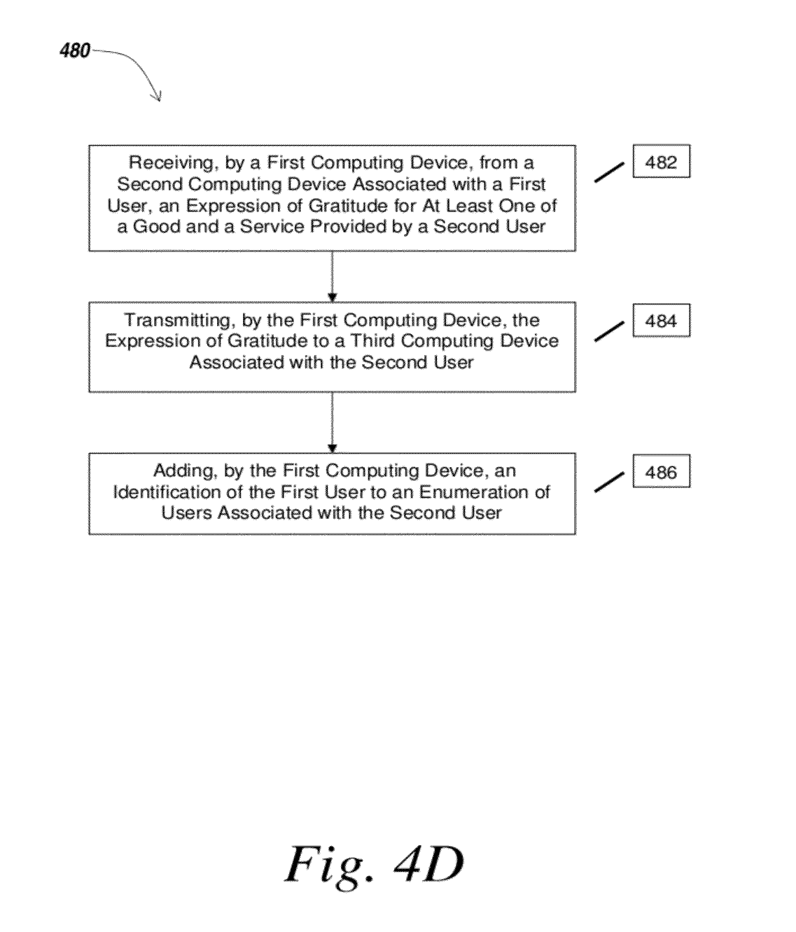

In one embodiment, and as will be discussed in further detail below in connection with FIGS. 4A-4D, the first computing device modifies a score associated with the second user, based on the expression of gratitude. In another embodiment, the first computing device modifies a score associated with the first user, based on the expression of gratitude. In yet another embodiment, the first computing device provides, to a third computing device associated with a fourth user, the first expression of gratitude and the second expression of gratitude for display to the fourth user; for example, the machine 106a may provide the expressions of gratitude for display as described above in connection with FIGS. 2A-2J.

Referring now to FIG. 3H, a flow diagram depicts one embodiment of a method 331 of expressing gratitude for value provided by an object. In this method, a first computing device receives, from a second computing device associated with a first user, an expression of gratitude for value provided by an object (332). The first computing device provides, to a third computing device associated with a second user, the expression of gratitude for display to the second user (334).

As discussed above, users may include non-human users, such as entities, organizations, or physical objects; such non-human users may be referred to generally as objects or as entities. In some embodiments, objects may include, without limitation, books, movies, music albums or songs, research papers, code, software, products, places, and events. By way of example, a human user who has a favorite park may feel appreciative of the park (and, by extension, of other individuals who frequent the park and of individuals who maintain the park); by creating an expression of gratitude for the value provided by the park, the user enables other users in his network to learn about the park, shares with others in his network about something important to him, and demonstrates a level of impact the park had on him. In some embodiments, the ability to quantify whether an event, a place, or other object provides any value by evaluating data indicating appreciation for the object may provide valuable insights to administrators, fund raisers, or other individuals associated with the object. In other embodiments, a profile for an object may be created based on imported data.

In some embodiments, an object may be a goal created by a user or community. In one of these embodiments, a goal of a project (which, as described above, is a type of community) is to produce an object. Communities (such as projects) may receive or provide expressions of gratitude, as discussed above; such expressions of gratitude may be transmitted to or from member users, including objects. In some embodiments, as a result of receiving or providing an expression of gratitude, a score of a member in the community and a score of the community may change.

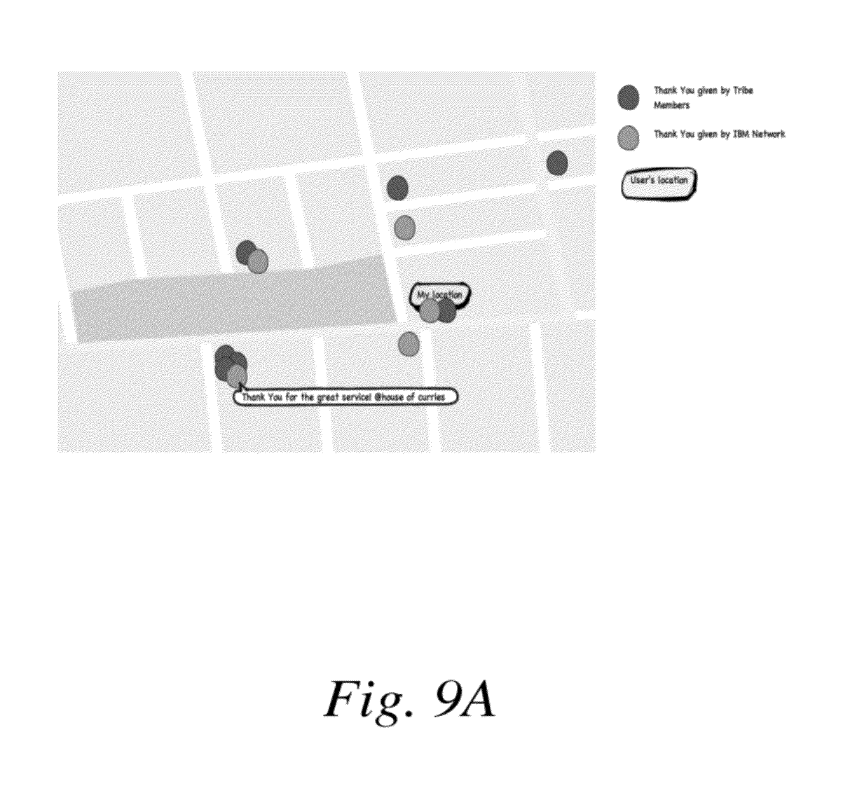

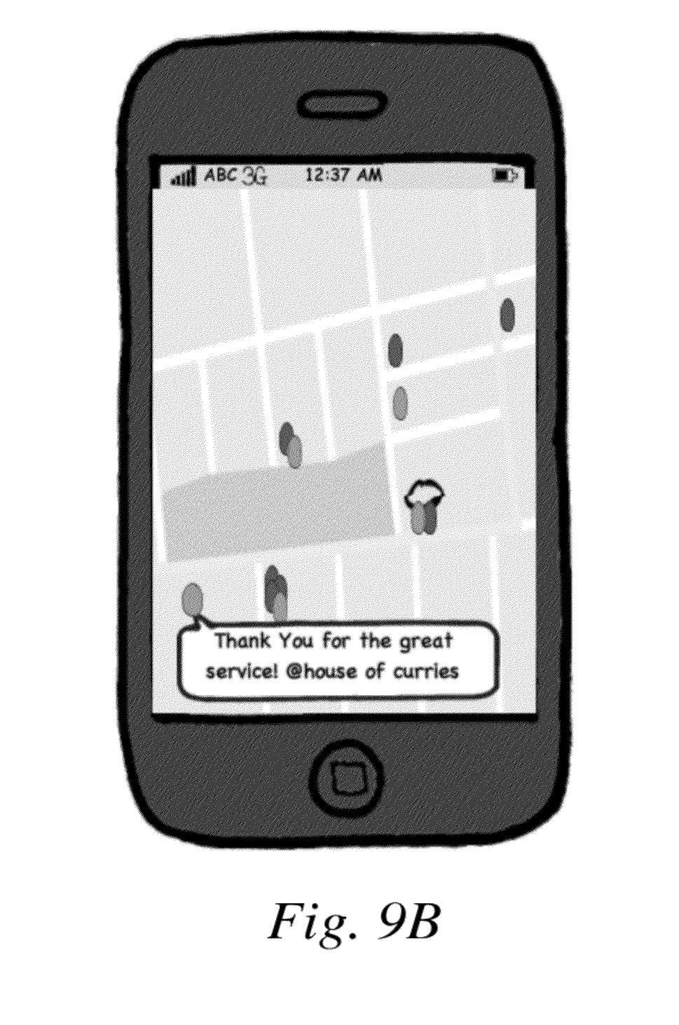

In some embodiments, a user may create a profile for a business, artist, band, public figure, company, organization, institution, brand, product, place, community, or other object. In others embodiments, the system creates profiles for users (including objects) automatically. As described in connection with FIGS. 9A and 9B, users may associate a place with an expression of gratitude. However, the embodiments described below are not intended to be limiting, as many types of objects, including those that are not places, may be associated with expressions of gratitude.

In one embodiment, the first computing device transmits the expression of gratitude to a fourth computing device associated with the object; for example, if the object is an event and an event coordinator has a computing device with which they post updates and news about the event, the event coordinator computing device may be the fourth computing device. As another example, the fourth computing device may be a shared, public computer at a library or other public venue. In another embodiment the first computing device transmits a gift with the expression of gratitude to the fourth computing device associated with the object. For example, a user generating an expression of gratitude for value provided by the object may wish to make a monetary donation to support upkeep of the object.

In another embodiment the first computing device associates a plurality of expressions of gratitude with the object. In another embodiment a first computing device provides to a fourth computing device associated with a third user, a subset of the plurality of expressions for display on the fourth computing device, the object identified in an enumeration of objects. As described above, members of a community may wish to see a subset of a plurality of expressions exchanged by other members of the community; such members may wish to include in the subset expressions of gratitude for value provided by objects in the community. For example, a new member of a community may want to know what places, events, causes, and other objects provide value in his or her new community.

In another embodiment, the first computing device transmits, to at least one of the first user and the second user, a recommendation based upon a characteristic of the object. In another embodiment, the first computing device transmits to at least one of the first user and the second user, a recommendation based upon a type of the expression of gratitude. In another embodiment the first computing device transmits to a fourth computing device, a recommendation for the object, based upon a characteristic of the first user.

In another embodiment the first computing device identifies a type of the expression of gratitude. In another embodiment, the first computing device receives an identification of a type of expression of gratitude. In another embodiment, the first computing device modifies a score associated with the object, based on the expression of gratitude.

In one embodiment the first computing device identifies a level of influence of the object on a plurality of users, based on the score. In another embodiment, the first computing device identifies a level of impact of the object on a plurality of users, based on the score.

In one embodiment, the first computing device adds an identification of the object to an enumeration of objects associated with the first user. In another embodiment the first computing device adds an identification of the first user to an enumeration of users associated with the object. In still another embodiment, the first computing device identifies the level of trust a user places in each of a plurality of objects.

Referring to FIG. 4A, a flow diagram depicts one embodiment of a method 400 for modifying a score based on an expression of gratitude. The method 400 includes receiving, by a first computing device, from a second computing device associated with a first user, an expression of gratitude for the at least one of the good and the service provided by a second user (402). The first computing device transmits the expression of gratitude to a third computing device associated with the second user (404). The first computing device modifies a score associated with the second user, based on the expression of gratitude (406). In some embodiments, and as described above, the step of transmitting the expression of gratitude to a third computing device associated with the second user can also include transmitting a gift to the second user with the expression of gratitude. In some embodiments, the influence, impact and trust calculation engine 206 modifies the score.

In some embodiments, when a user, A, posts thanks to another user, B, the user giving thanks (A) receives one point for each number of thanks given or expressed and the recipient of the thanks (B) receives one point for each number of thanks received. In some embodiments, the count of the number of thanks given/expressed is referred to as “Human Capital”. In one embodiment, this count increases every time a user gives thanks to another user. In another embodiment, the count of the number of thanks received is referred to as “Thank You Capital”. In still another embodiment, this count increases every time a user receives thanks from another User. In other embodiments, the term “Capital” is an inclusive term used to refer to both Thank You Capital and Human Capital.

In one embodiment, an aggregate Thank You Capital value referred to as a GTP indicates a level of capital for all members of a particular network, such as a geographic network like a nation. In one embodiment, an aggregate level of Human Capital for a particular network, such as a geographic network like a nation, is referred to as a GHP. GTP and GHP may be displayed visually using color indicators to differentiate between range values for GTP and GHP. In some embodiments, for example for geographic networks, this information may be displayed on a geographic map. In other embodiments, for example for non-geographic networks, the information may be displayed in a table or using other visualizations such as circles and connecting lines.

Referring still to FIG. 4A, in one embodiment, the first computing device identifies a level of influence of the second user on a plurality of users, based upon the score. In another embodiment, the first computing device identifies a level of trust of the second user by the first user, based upon the score. In still another embodiment, the first computing device identifies a level of impact of the second user on a plurality of users, based upon the score. In some embodiments, the influence, impact and trust calculation engine 206 identifies the level of trust, the level of impact, and the level of influence.

In one embodiment, the first computing device modifies the score associated with the first user, based on the expression of gratitude. In another embodiment, the first computing device receives, from a fourth computing device associated with a third user, a second expression of gratitude for one or more good(s) or service(s) provided by the second user, the third user and the second user each identified in an enumeration of users in a community. In this embodiment, the first computing device generates a second score for the second user based on the second expression of gratitude.

In one embodiment the first computing device associates a plurality of expressions of gratitude with the second user. In another embodiment, the first computing device provides, to a fourth computing device associated with a third user, a subset of the plurality of expressions for display to the fourth user, the second user and the fourth user each identified in an enumeration of users in a community.

In one embodiment the first computing device transmits, to at least one of the first user and a third user, a recommendation based upon a characteristic of the second user. In another embodiment, the first computing device transmits, to at least one of the first user and a third user, a recommendation based upon a type of the expression of gratitude. In another embodiment, the first computing device transmits, to the third computing device, a recommendation for the second user, based upon a characteristic of the first user. In another embodiment, the first computing device transmits, to the third computing device, a recommendation for the second user, based upon a type of the expression of gratitude.

In another embodiment, the first computing device identifies, a type of the expression of gratitude; for example, the topic indexing engine 218 may identify the type of the expression of gratitude. In another embodiment, the first computing device receives, an identification of a type of the expression of gratitude; for example, a user may provide the identification of the type. In another embodiment, the first computing device generates a second score based upon a type of the expression of gratitude.

In calculating scores, the machine 106a may use other factors instead of basing scores directly or indirectly on the expression of gratitude. For example, in one embodiment, the score is based on a number of expressions of gratitude received or a number of expressions of gratitude sent while in other embodiments, the score is based on the number of users from whom the user received expressions, the number of users to whom the user sent expressions of gratitude, or the number of users in a community to which the user belongs.

Referring now to FIG. 4B, a flow diagram depicts one embodiment of a method 410 for generating changes in scores and community membership upon sending or receiving an expression of gratitude. The method 410 depicts another embodiment of the method 400. In this embodiment, when a first user (“A”) sends an expression of gratitude to a second user (“B”) (412), user A increases his human capital by one or more points and user B increases his thank you capital by one or more points (414). Further, as will be described in further detail in connection with FIG. 4D, user A may be added to a community associated with user B and a formal relationship may be created between them within the system. User B is added to a community associated with user A (for example, a network, or “Thank You Tribe” as described below) and another relationship is created (416). In other embodiments, calculations related to the expression of gratitude such as capital for topics, trust, impact, and influence may also be performed. In another embodiment, a process runs in the background, performs the calculations, and creates the relationships asynchronously.

Referring now to FIG. 4C, a block diagram depicts an embodiment of a system in which users receive recognition for exchanging expressions of gratitude. In one embodiment, the first computing device transmits, to a computing device associated with a user, an identification of a reward for the user, based upon the score. In some embodiments, a user can earn or receive awards in a Thank You Network. In one of these embodiments, an award is displayed on a user's profile. In another of these embodiments, the system may give awards to users when they reach a certain range of values for Thank You Capital, Human Capital, or accumulate a certain number of members in their Thank You or Gratitude Tribe, or perform a certain number of other actions within a Thank You Network. In still another of these embodiments, a hierarchy of such awards may exist. In other embodiments, these awards may be related to completing a certain number of activities or actions on the Thank You Network within a given period of time. For example, a user that sends more than five expressions of gratitude in a week may be given an award called “Truly Grateful.” In some embodiments, awards may be a good or a service. In other embodiments, awards may be permission to access or use restricted items such as, without limitation, goods, services, and venues.

Referring to FIG. 4D, a flow diagram depicts one embodiment of a method 480 for receiving and transmitting expressions of gratitude. A first computing device receives, from a second computing device associated with a first user, an expression of gratitude for at least one of a good and a service provided by a second user (482). The first computing device transmits the expression of gratitude to a third computing device associated with the second user (484). The first computing device adds an identification of the first user to an enumeration of users associated with the second user (486). In one embodiment, the method includes transmitting a gift to the second user with the expression of gratitude.

In one embodiment, as a result of sending an expression of gratitude, a first user is added to a second user's list of users that have sent the second user expressions of gratitude. In another embodiment, a list of users that have given thanks to the specified user is referred to as a “Gratitude Tribe.” In still another embodiment, the second user is added to the first user's list of users to whom the first user has sent expressions of gratitude. In yet another embodiment, a list of users that have received thanks from a specified user is referred to as the “Thank You Tribe.” In some embodiments, the term “Tribe” is used to refer to both Thank You Tribe and Gratitude Tribe. In one embodiment, the term “relationship” is used to describe that one user belongs to another user's Thank You Tribe, Gratitude Tribe, or both.

In one embodiment, the first computing device transmits, to at least one of the first user and a third user, a recommendation based upon a characteristic of the second user. In another embodiment, the first computing device transmits to the at least one of the first user and the third user, a recommendation based upon a type of the expression of gratitude. In another embodiment, the first computing device transmits to a third computing device, a recommendation for the second user, based upon a characteristic of the first user. In another embodiment, the first computing device transmits to the third computing device, a recommendation for the second user, based upon a type of the expression of gratitude.

In another embodiment, the first computing device adds an identification of the second user to an enumeration of users associated with the first user. In another embodiment the first computing device identifies a type of the expression of gratitude. In another embodiment the first computing device receives an identification of a type of the expression of gratitude.

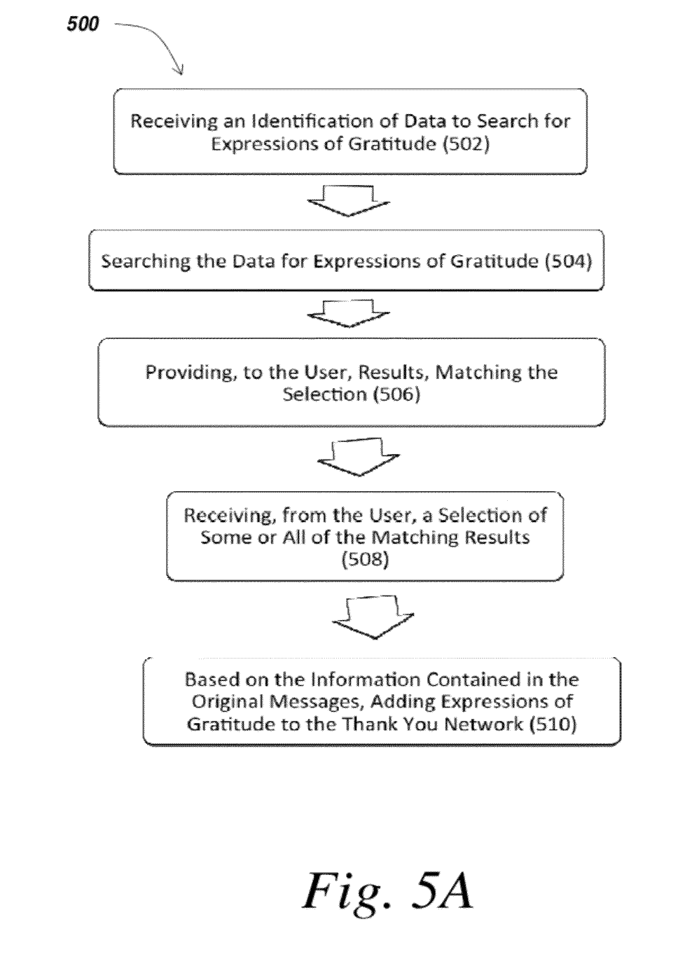

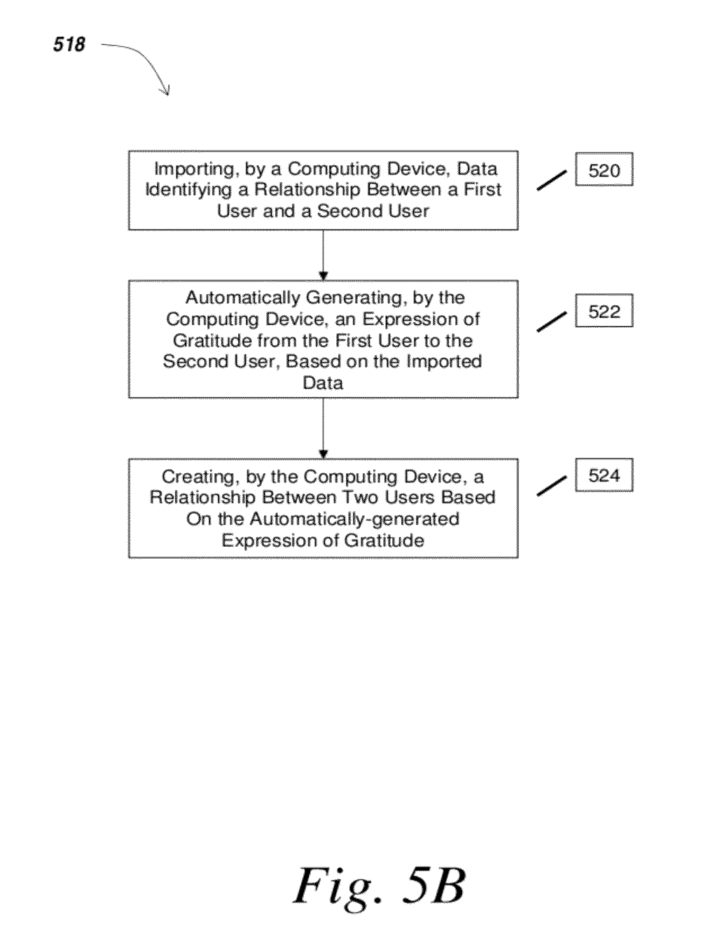

Referring to FIG. 5A, a flow diagram depicts one embodiment of a method 500 for importing data, which may include previously generated expressions of gratitude. The method 500 includes receiving an identification of data to search for expressions of gratitude (502). In one embodiment, the identification includes a specification of words, images, or other criteria based on which selections will be made. The method 500 includes searching the data for expressions of gratitude (504). The method 500 includes providing, to the user, results matching the selection (506). The method 500 includes receiving, from the user, a selection of some or all of the matching results (508). The method 500 includes adding expressions of gratitude to the Thank You Network, based on the information contained in the original messages (510).

In some embodiments, users, administrators of private networks, and administrators of private Thank You Networks can recreate an existing network on the Thank You Network by importing the data from another network directory such as a corporate LDAP directory; this information can be imported via uploading a file to the Thank You Network or by establishing a network link to the application storing the information. In other embodiments, the expression generation engine 202 may include an expression importer 215 that accesses data stored on a second, external system (such as a user's external email system), identifies expressions of gratitude within the data, and imports the identified expressions into the system. In some embodiments, the expression importer 215 adds users (including, for example, individuals, communities, organizations, networks, projects, and objects) to the system based on imported information.

In one embodiment, a software process may run on any of the above-mentioned entry points and search any of the above mediums to find documents, media, and other data that contain expressions of gratitude, by searching for keywords and visuals provided by a user in those media. In another embodiment, the user may elect to run this process in real time so that the expressions of gratitude are copied to the Thank You Network at any time when an expression of gratitude is created on another network, service or entry point. For example, a user may search for past emails containing the word “Thanks” (or the equivalent in a foreign language); the user may select emails from the search results for submission to the Thank You Network; upon submission, Thank You(s) are sent to the Users and Non-Users that were thanked in the said emails.

In another embodiment, by way of example, the user executes the import process on data stored in another social network, such as Twitter, where the user may indicate that a particular term (e.g., “thx”) should be searched; in this example, posts on Twitter containing “thx” are returned, the user selects some/all for submission to the Thank You Network, and corresponding expressions of gratitude are created. Alternatively, the user can elect for all matching posts on micro-blogging services (such as, for example, the service provided by Twitter, Inc., of San Francisco, Calif.) to be automatically submitted to the Thank You Network. In some embodiments, the system identifies users and non-users as recipients of data in the system. In one of these embodiments, the system adds the identified users and non-users into the system.

Referring to FIG. 5B, a flow diagram depicts one embodiment of a method 518 for creating a relationship between two users based on an automatically generated expression of gratitude. The method 518 includes importing, by a computing device, data identifying a relationship between a first user and a second user (520). The computing device automatically generates an expression of gratitude from the first user to the second user, based upon the imported data (522). The computing device creates a relationship between two users based on the automatically generated expression of gratitude (524).

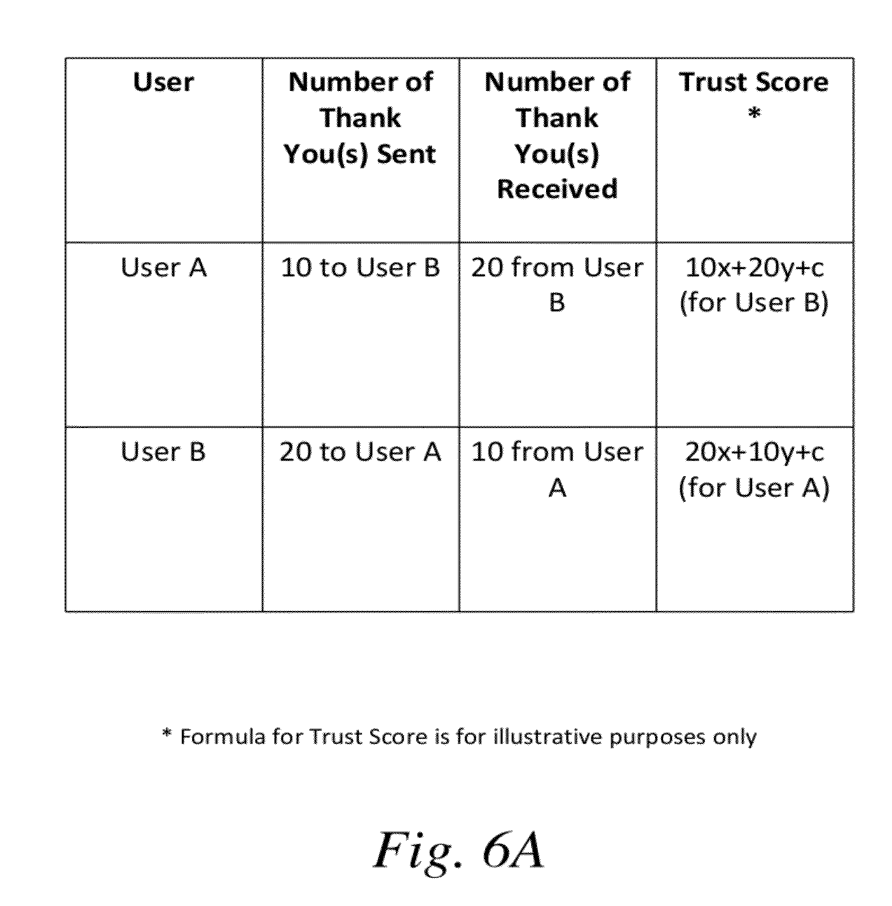

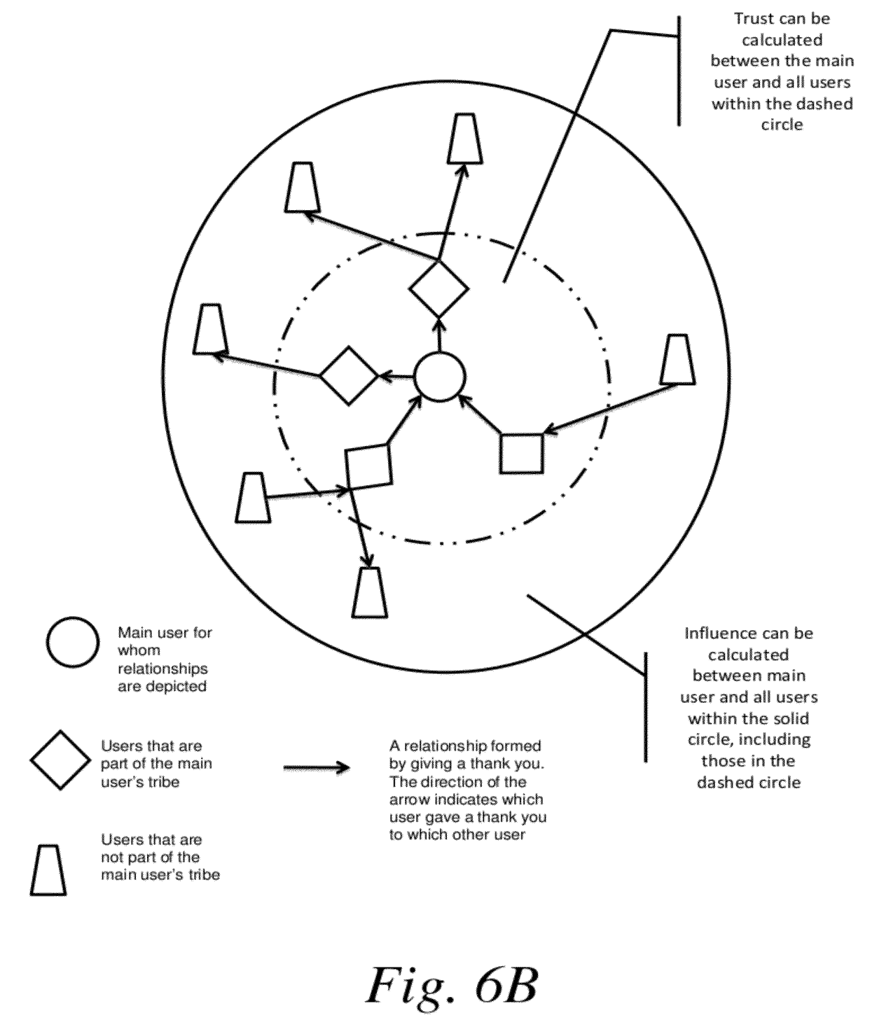

Referring now to FIG. 6A, a diagram depicts an embodiment of a method for measuring the number of Thank You(s) exchanged between two users, weighing it with the frequency with each user expresses or receives thanks, and arriving at a numerical score which is an indication of the “trust” that one user places in another user. In some embodiments, certain types of gifts and awards may also contribute to “trust.”

In one embodiment, this score is unique for each user, and might be different for each user within a pair. For example, a first user might have a high level of trust in a second user as indicated by a high trust score and the many expressions of gratitude given to the second user, but the second user might trust the first user less as indicated by the lesser number of expressions of gratitude and the lower trust score given to the first user.

Similarly, trust scores can be created for a user on particular topic(s). In one embodiment for calculating this score, a higher weighting is given to expressions of gratitude received by the user that contain the keywords relevant to particular topic(s). For example, a trust score can be calculated for a user in the work network of Oracle Corporation, for the topic of marketing campaign. This trust score would be an indication of how much other users within the Oracle Corporation have benefited from the given user's assistance with marketing campaigns, and as a result reflect their trust score in the given user's ability to work on marketing campaigns.

In one embodiment, influence is a numerical score calculated between two entities within a Thank You Network. An entity can by any type of user, including without limitation, objects, communities, tribe, network, or topic. In some embodiments, expressions of gratitude do not need to have been exchanged directly between the entities in order to calculate influence score.

In one embodiment of the method, and as shown in FIG. 6B, Influence can be measured between two Users, A and B, who may not have directly exchanged Thank You(s) with each other, but are connected by a shared a Relationship or chain of Relationships. For example, User A may have a Relationship (have given or received a Thank You) with one or more Users, X, Y, Z who form a chain of Relationships that connects A to B. Membership in common Networks can also be a factor affecting one User's influence over another. Depending on the Trust between user A and the intermediary Users, A might be able to exert influence on B through them. Influence maybe calculated relative to the Trust between B and X, and X and A. If the Trust of B for X is high and X for A is high, then A is likely to have a high Influence for B. In another embodiment of the method, Influence is unidirectional and will be calculated separately for each user in an influence relationship.

Influence of a user on a community or for a particular topic can also be calculated. In one embodiment, the Influence of a User for a particular Network can be determined by taking an aggregate of the Trust between a specific User and other Users within the network and weighting it by the number of Users within the network. Other mathematical/statistical techniques for determining this score maybe used. Such a number would reflect the amount of influence that the User has over the entire Network.

For example, John might have received 15000 Thank You(s), 9000 of which are from Users that belong to the IBM network. In this example, John's influence score for the IBM network would be calculated with a higher weight given to the expressions of gratitude received from or given to other users that belong to the IBM network, and be relative to the scores that other users within the IBM network have, the number of unique users that have thanked John or John has thanked, as well as the total number of users in the IBM network. Similarly, and as a further example, in order to calculate a level of influence for a particular topic, such as investment advice, expressions of gratitude received related to investment advise would be used to determine John's influence for investment advise. In some embodiments, knowing a user's level of influence over a topic can be useful in a variety of scenarios. For example, a customer seeking help with investments might want to know the level of influence that a particular investment advisor has for investments in municipal bonds; knowledge of the investment advisor's influence for municipal bonds could be used to determine the effectiveness with which the investment advisor has handled other customer's investments in municipal bonds.

In one embodiment, impact is a numerical score calculated between two entities within a Thank You Network. An entity, as mentioned above, may refer to any type of user or community of users (including objects, tribes, networks, or topics). In some embodiments, at least one of the two entities is an object. In still another embodiment, a level of impact of a user on a community or for a particular topic may also be calculated.

In some embodiments, users are provided the option to restrict access to any information on their profile; these restrictions may be applied to specific tribe members, to specific networks, to specific users or other user-specified groups. In some embodiments, an option to send a Thank You privately is provided. In one embodiment, such a Thank You is visible only to the sender and the recipient. In another embodiment, users can elect to make all Thank You(s) received private by default; in this scenario, if a sender wants to make a Thank You public, he/she has to request permission from the recipient and vice versa.

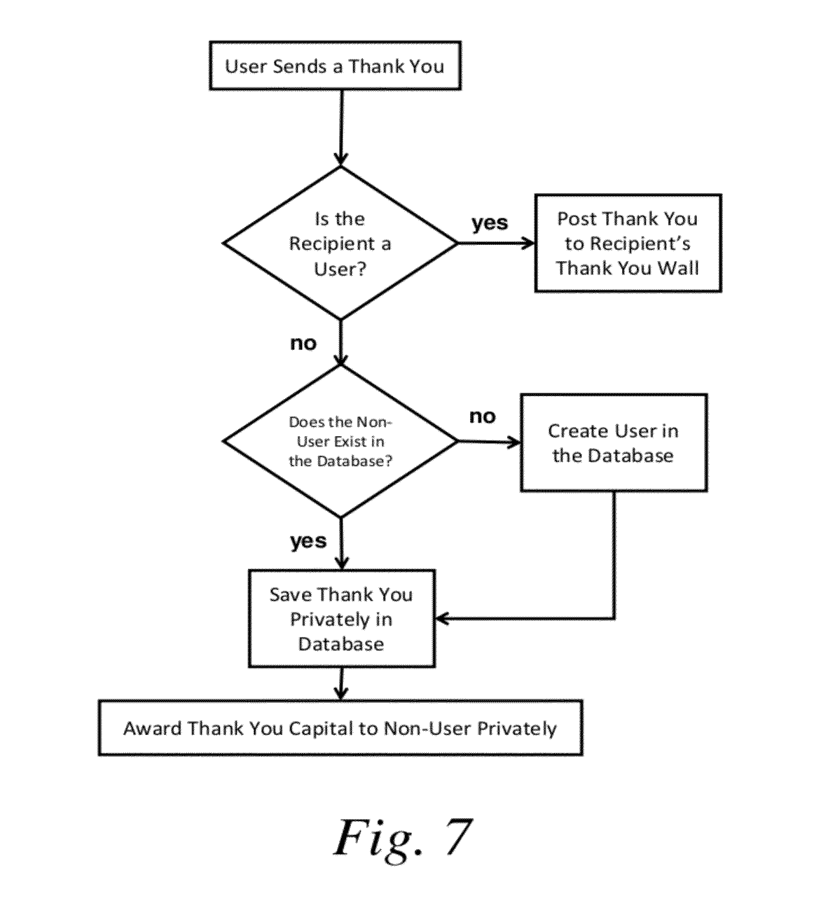

As shown in FIG. 7, and in one embodiment, if a Thank You(s) is sent to recipients who are not part of the Thank You Network but some form of contact information is available, a non-user is created in the Thank You Network and the Thank You is recorded as given to the non-user. A notification may be sent informing the user of this event. In one embodiment, a Thank You can be visible on the sending user's Gratitude Journal and the sending user is awarded Human Capital; the non-user is also awarded Thank You Capital, but their profile or any other information including Thank You(s) may not be visible to any user of the Thank You Network. In another embodiment, if the non-user already exists in the Thank You Network, the Thank You is added for him and changes to Capital and Relationships are recorded in the database; when the non-user signs up for the Thank You Network, he is given the choice to make the past Thank You(s) public or private. In still another embodiment, the Capital and Relationships created before the non-user signed up automatically get added to his profile.

A user's profile can indicate that she has been confirmed as a real individual or a real world organization by a method of verifying identity. Proof may be submitted by uploading documentation such as driver's license, social security number, or voter registration to the Thank You Network. In some embodiments, upon verification, the user's profile is changed to say that the user has been confirmed to be a real user.

Alternatively, the user may be provided the option to use another service that the Thank You Network can communicate with to confirm the identity. Such a service would use a method of identification that is acceptable to the Thank You Network. In this way, the user can confirm identity without submitting documentation directly. An example of such a service could be a Corporate Personnel Directory (LDAP). Separate capital, relationships, levels of trust, levels of influence, levels of impact, and scores generally may be calculated and stored for confirmed Users.

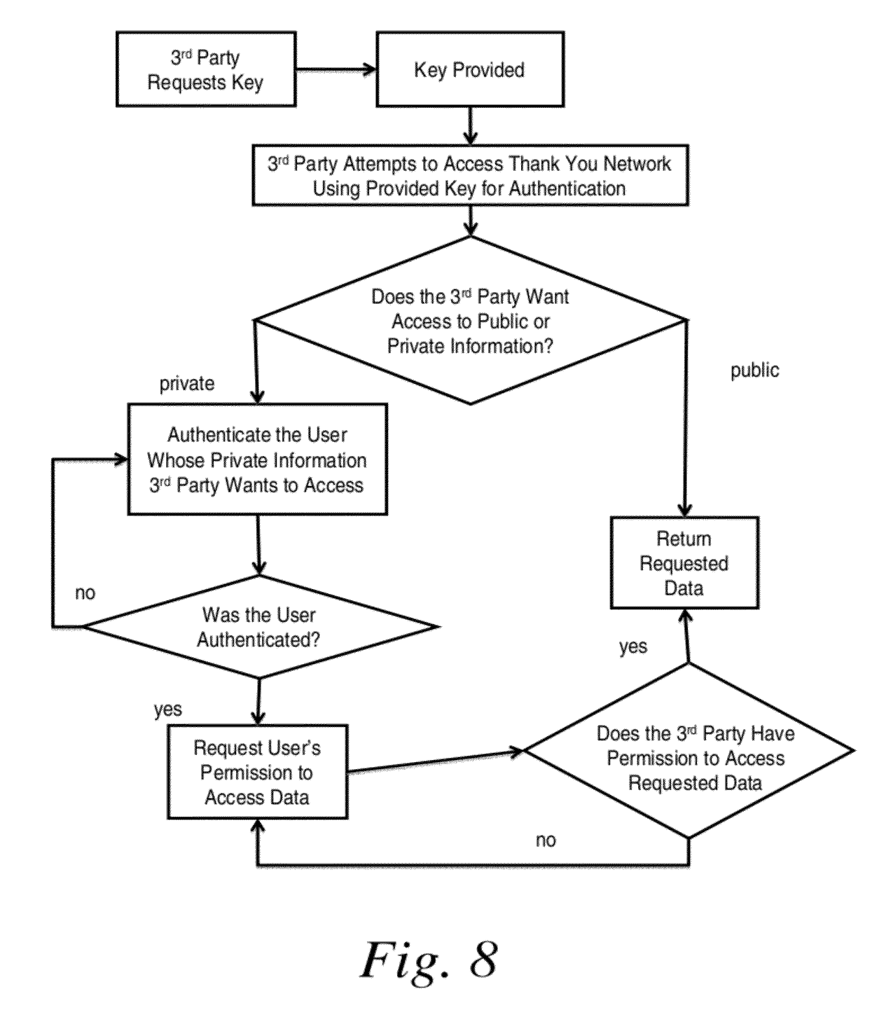

FIG. 8 is a flow diagram depicting one embodiment of a method in which a third party obtains user consent to request information from a Thank You Network. In one embodiment, in order to access a user's information, a third party site, network, service, or application needs to obtain the user's consent to request the user's information from the Thank You Network. In another embodiment, the third party registers with the Thank You Network before making any requests. In still another embodiment, the third party authenticates the User using the method for authentication, and confirms that the user has granted permission to access the type of information requested. In another embodiment, the third party will be granted access to the requested information subject to the User's privacy settings. For example, the third party might request a listing of the User's Tribe to find which Tribe members already use the third party's service. In yet another embodiment, in order to access public information, the third party may directly request the information from the Thank You Network without authenticating the User.

In one embodiment, a message is a digital object of communication sent, typically privately, between users. In another embodiment, a message is distinct from an expression of gratitude. In still another embodiment, it may be sent directly by visiting a user's profile, from ames sage section, or in response to a Thank You by clicking on the reply option next to a Thank You. In yet another embodiment, a user might be charged to send messages to certain users within the Thank You Network. For example, a user may be charged to send a message to users not within their tribe. In some embodiments, introductions and favors are special types of messages. In other embodiments, messages may be transmitted via email. In still other embodiments, messages, and expressions of gratitude may be forwarded to external email systems on behalf of users.

In some embodiments, a request for assistance sent from a first user to a second user, as a message, is referred to as a favor; in such a message, the sender specifies an action, service, or other request with which the second user can assist the first user. A user can include digital media in a favor message explaining the favor. A user can be charged to request favors from other users in the Thank You Network.

In one embodiment, the second user is presented three options in the message i) accept, ii) ignore, or iii) deny. In another embodiment, if the second user accepts the favor message, then an expression of gratitude from the first user to the second user is created which will be posted to the second user's profile after a specific time interval has elapsed. In still another embodiment, the first user will be given the choice to customize the content of the expression of gratitude within that specific time interval. In another embodiment, a generic expression of gratitude will be posted to the second user's profile. In still another embodiment, if the second user ignores the favor, no further action is taken. In yet another embodiment, if the second user denies the favor, then the first user is notified of the denial.

In some embodiments, a request from a first user to a second user to introduce the first user to a third user is referred to as an introduction. In one of these embodiments, an introduction request is sent from the first user to the second user, with possible documents/digital media that might be helpful to the second user in introducing the first user to the third user. In another of these embodiments, the second user may choose to accept, ignore, or deny the request for introduction. In still another of these embodiments, the second user accepts the request for Introduction, the second user is presented with a screen to create an Attempting to Introduce Request (AIR) to send to the third user along with an option to select materials provided by the first user. In another of these embodiments, the second user may determine whether to share the AIR with the first user. In still another of these embodiments, if the third user accepts the AIR, the request for introduction is complete and an Introduction Thank You is created for the second user from the first user. In yet another of these embodiments, the third user is given the option to send an Introduction Thank You to the second user.

Referring now to FIG. 9A, a block diagram depicts one embodiment of a system displaying an expression of gratitude associated with a map. In one embodiment, the system includes a display of a user's current location on the map and Thank You(s) that are associated with locations and places near the user's current location, and an option to display additional details of a particular Thank You may be displayed.

In one embodiment, a location refers to a geographic point, and a place refers to a named location. An example of a Place would be “Bruno's Italian Restaurant, San Francisco.” In some embodiments, the system includes functionality for expressing gratitude, or viewing the expressions of others, at a location or place. In one of these embodiments, the system includes functionality such as the object engine 220 shown in FIG. 2A to provide this functionality. In another of these embodiments, the expression of gratitude is an implicit recommendation for the location or place.

In some embodiments, a user can associate a location or a place with an expression of gratitude that they are sending. In one of these embodiments, the user can also opt to automatically include their Location in their expression of gratitude. In another of these embodiments, the location of the expression of gratitude can also be derived from the location of either i) the user sending the Thank You, or ii) the user receiving it. In still another of these embodiments, a location or a place can accumulate capital when an expression of gratitude is associated with that Location or Place. In yet another of these embodiments, users can view the expressions of gratitude associated with a particular location or place as well as see the capital for a particular location or place; for example, a user can visually view the expressions of gratitude at a location or place on a geographical map, in tabular form or other formats.

As shown in FIGS. 9A and 9B, and in some embodiments, if a User provides the Thank You Network with her current Location, she can be shown all the Thank You(s) expressed near her current Location. The user can opt to filter these Thank You(s) by various criteria such as Thank You(s) given by members of her Tribe, by members of certain Network(s), by Users that live at or near that Location, by Users having a Capital greater than a specified number, by Places, or by other User specified criteria.

In some embodiments, a user gives a Thank You to a potential user or non-user for whom no means of contact is available (such as a name, email, or phone number). In one embodiment, the term “stranger” is used to refer to a potential user or non-user for whom no means of contact is available (such as a name, email, or phone number). A stranger may or may not be a member of the Thank You Network. A stranger may be identified with a label such as a “Wells Fargo Customer Service Rep Ricardo” or “Homeless guy at 3^{rd} St and Main St.” Such a Thank You may be referred to as a “Floating Thank You”. A floating thank you may also be associated with a location or place. One example of a floating thank you may be to thank someone for giving up his or her seat on a bus to an elderly or disabled passenger. In one embodiment, when the stranger becomes a user of the Thank You Network he or she may claim “Floating Thank You(s).”

In one embodiment, a user can claim a Floating Thank You(s). In another embodiment, a user may search the Thank You Network for Floating Thank You(s) that might apply to him, and send requests to the users that originally expressed the Thank You to claim the Floating Thank You(s). If the user that expressed the Thank You approves the request, the Floating Thank You is converted to a regular Thank You.

Referring now to FIG. 10, a block diagram depicts one embodiment of an interface providing social context on a user's home page including an identification of, by way of example, two books that other users, who belong to the logged-in user's Thank You Tribe, have added to their wish lists, with an option to add those books to the wish list for the logged-in user. In one embodiment, a method provides recommendations for products, services, features, and applications that members of a user's tribe or networks have directly or indirectly recommended or used on the Thank You Network; such recommendations may include items mentioned in expressions of gratitude, or added to wish lists. As these recommendations provide a context for the item being recommended based on the activity of other users that belong to the given user's tribe or networks, in some embodiments, the recommendations are referred to as “tribe context”. In one embodiment, recommendations are displayed within the Thank You Network or in interfaces such as widgets outside the Thank You Network. In another embodiment, recommendations are displayed as advertisements, and the Thank You Network is compensated for them. In still another embodiment, third parties with permission to access Thank You Network information may also display these recommendations. As shown in FIG. 10, a user is shown a recommendation for a product from another user in his tribe who has added the product to her wish list. As another example, a user may be shown a new feature within the Thank You Network that another User in his Tribe is using.

In some embodiments, a method provides recommendations for products, services, features, and applications that members of a user's community (e.g., the user's tribe or networks) have directly or indirectly recommended or used on a third party service, application, site, or network. As these recommendations enable a user to discover an item on a third party's service based on the activity of other users that belong to the given user's tribe or networks, the recommendations are referred to as “tribe discovery”. In one of these embodiments, recommendations are displayed as advertisements and the Thank You Network may be compensated for allowing the display. In another of these embodiments, tribe discovery recommendations are displayed in the Thank You Network as well. In still another of these embodiments, and by way of example, a member of a first user's tribe installs an application from a third-party application store and a recommendation for this application is be displayed to the first user when he visits the application store; this recommendation may include the name of the tribe member that installed the application.

In some embodiments, a level of trust or influence between two users impacts whether or not an item is recommended, or how strongly the item is recommended. For example, and in one embodiment, if analysis of user data indicates that User A is more likely to buy a product or add an item to his wish list when User B has acquired or added the same item to her wish list, the system may use that data in determining whether to recommend an item to User A—the system may decide to recommend more items from User B's profile than from a third user, C, where an analysis of user data indicates that User A is more influenced by User B than by User C.

In some embodiments, a user's access to resources and actions is metered using control criteria such as time, and total usage. In one of these embodiments, a user can be restricted from performing more than a certain number of actions to maintain the integrity of the network and avoid inconvenience to other users. For example, a user may be prevented from expressing more than 10 Thank You(s) per minute. Other users may have the option to click a button that says “Report Abuse” to report a violation of the site's content or other policies by another user. In another embodiment, a user with multiple abuse reports may be blocked from performing certain actions or using the site entirely. In still another embodiment, users may click on a button to “Block” another user from posting or viewing their profile. In yet another embodiment, a blocked user is added to a censored list, which prevents him/her among other things from being able to send Thank You(s) to that User, or view that User's profile.

In one embodiment, a user can run a query (or report) through an interface to analyze Thank You Capital, Human Capital, and other Thank You Network data or statistics. In some embodiments, the system utilizes components shown in FIG. 2A to perform these searches. In one of these embodiments, the system includes a search engine 216, a topic-indexing engine 218, and a statistical calculations and caching Engine 224. In another embodiment, a query is sent to a statistics and search engines and results are returned that match the specified criteria. Some of the ways in which the user can query the data or create a report include, in some embodiments, searching by topics, networks, and tribes. For example, a user may query to find out the Thank You Capital for another user by network (e.g. geographic network or company network). In this example, the Thank You Capital for the expressions of gratitude received by the specified User from other members of the given Network are calculated and displayed. As an example, a user evaluating different companies that have extended job offers to the user may evaluate each company's capital, either at the individual level (capital for future colleagues) or company-wide. In one embodiment, a visual display of relationships in tribes and networks is also available showing capital for users; the display may be made available both inside and outside the thank you network. In some embodiments, a tribe graph and relationships engine 226 generates the visual display.

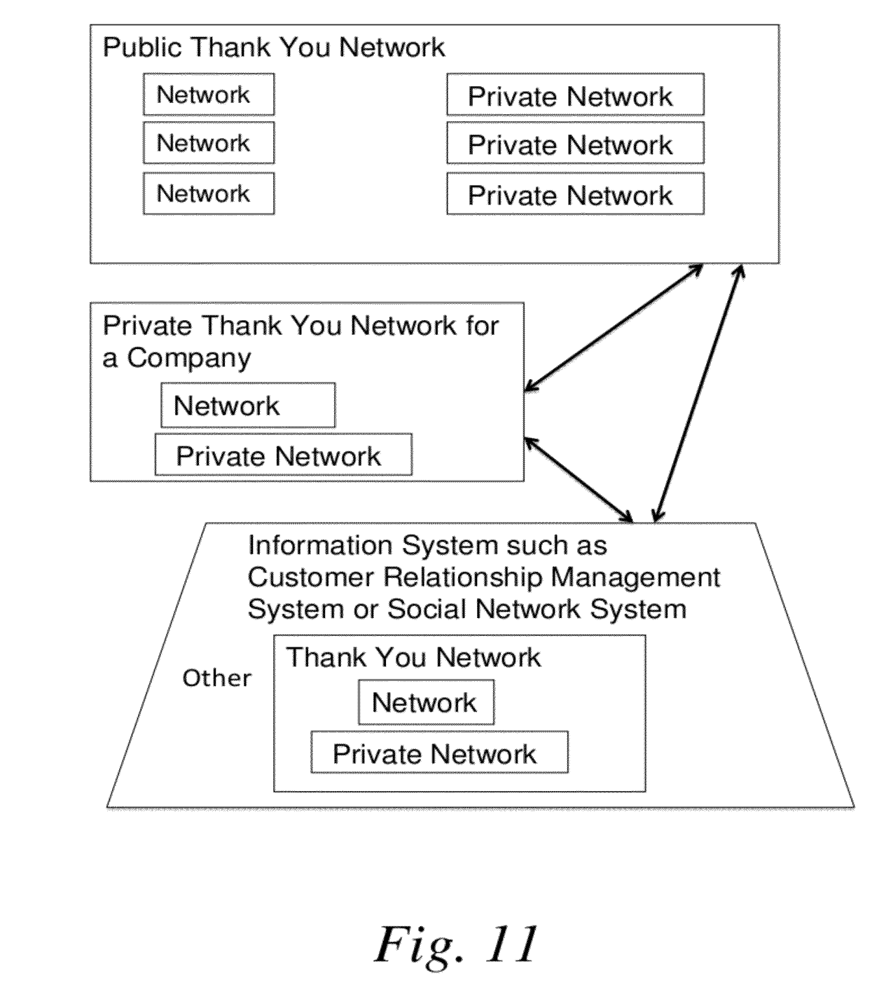

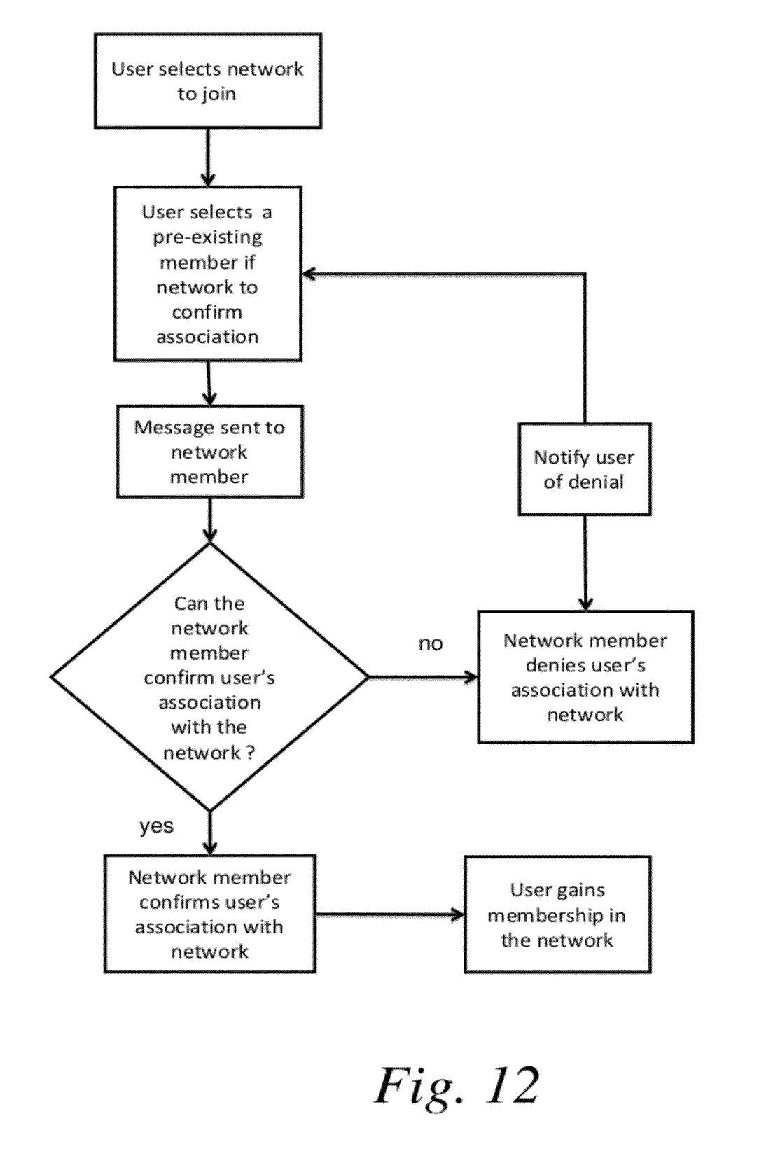

Referring now to FIG. 11, a block diagram depicts one embodiment of a system in which multiple public and private Thank You Networks are in communication with each other. In one embodiment, a private Thank You Network, also known as an enterprise Thank You Network, is a Thank You Network that may be restricted to users belonging to a particular network such as a company, an organization, an institution, or other collection of individuals. In some embodiments, some or all of the functionality described above—the systems and methods of the Thank You Network, including functionality such as gifts, awards, and wish lists—may be made available in a private Thank You Network. In other embodiments, calculations of various scores, such as Thank You Capital, can be performed specifically for users of a private Thank You Network.

In one embodiment, a private Thank You Network may be hosted on separate servers from a generally available, public Thank You Network. In another embodiment, the enterprise Thank You Network may be accessible only within an organization's intranet. In yet another embodiment, it may be a part of the public Thank You Network with privacy options for Thank You(s) exchanged between members that belong to the Private Thank You Network. In some embodiments, the content of the Thank You(s), Capital earned, and the Relationships formed through the exchange of Thank You(s) in a Private Thank You Network can be made private or public through the administration interface and may not be visible to Users that don't belong to it.

In other embodiments, the Private Thank You Network may be embedded in other systems, such as a customer relationship management system, or asocial network service, such as Facebook. As shown in FIG. 11, Private Thank You Networks may communicate and share information with the Public Thank You Network and other Private Thank You Networks.

In some embodiments, a private Thank You Network may have one or more administrators that have control over the privacy, visibility, accessibility, user management and other configuration options. In one of these embodiments, administrators of the private Thank You Network might create custom awards for the private Thank You Network. In another of these embodiments, the administrators may elect to automatically give certain awards when a user in the organization reaches a certain range of values for a given activity. In still another of these embodiments, a private Thank You Network is created without an administrator, then defaults provided by the system may be used.

In some embodiments, visibility is an ability to view all or some portion of the content listed on a user's profile. In one of these embodiments, visibility can be restricted to users belonging to particular sub networks, to a role-based hierarchy, or to other selections of users and groups as defined by an administrator of the private Thank You Network. In another of these embodiments, visibility controls are available for various components such as the content of Thank You(s), Capital, Tribes, Networks, Wish lists, and other information pertaining to a Private Thank You Network.

In some embodiments, access to a private Thank You Network may be restricted to users with exclusive access points or with additional authentication information. In one of these embodiments, and by way of example, users of a private Thank You Network (e.g., managers in a company) may periodically view their employee's interests by visiting the profile and reward the employee with a gift based on the interest indicated by the employee, such as a ticket to a Giants game in San Francisco, or pick one of the gifts on the employee's wish list. In another of these embodiments, managers may also elect to give virtual awards to their employees for meeting certain criteria such as delivering a project on time. In yet another of these embodiments, an Administrator for a company may elect to automatically give an award when an employee's Thank You Capital within the private Thank You Network becomes greater than a user-specified threshold.

In some embodiments, some networks, such as corporate networks, can be claimed by a verified administrator as determined using the above system for determining membership in a Network. In one of these embodiments, the administrator is presented with the option of making the network a private network. In another of these embodiments, in exchange for a fee, the administrator can impose certain requirements such as the manner in which Thank You(s) can be expressed, including changing the visibility of the message content so that it is visible only to members within the Network even though the points and the relationships between users might still be visible to users that are not part of that network. In still another of these embodiments, such a network behaves substantially similar to a private Thank You Network.

In some embodiments, organization members are individuals that are a part of a real-world collection of individuals, such as employees or volunteers. In some embodiments, these organization members may be part of a particular network on the Thank You Network, and such a network might be used to form a private Thank You Network. In one of these embodiments, such a network may contain other sub-Networks. In another of these embodiments, organization members express Thank You(s) to each other by posting on each other's profile, and building Thank You Capital and Human Capital within the organization.

In some embodiments, information about organization members, including contact, specialties, interests, departments, managers, and other information, is entered directly into a profile for the organization or imported from another database/network/directory. In other embodiments, organization members can subscribe to receive notifications on their home page or via email when other organization members post Thank You(s) or perform other activities. For example, managers can subscribe to receive updates when Thank You(s) are posted to the profiles of the employees that report to them directly or indirectly; such information may be a vital indicator of the employee's performance at the company.

In some embodiments, a class of organization members, such as managers, can run reports and view visualizations on Thank You(s) received by other organization members, such as employees. In one of these embodiments, with the appropriate permissions, special users like managers can select criteria by which to aggregate Thank You Capital/Human Capital for another user like an employee. For example, a report can be run to find the Thank You Capital earned in the Marketing Department for an employee in the Research Department to evaluate collaboration across departments. Similarly, and as another example, another report could be used to evaluate the Thank You Capital earned by an employee within the same department as a measure of his direct impact on peers.

In some embodiments, the reporting, filtering, and aggregation of Thank You Capital as well as other metrics in the Thank You Network can be done according to criteria such as Individuals, Departments, Customers and Business Partners (in case the Organization allows outsiders to give Thank You(s)), Time (e.g. Quarterly, Yearly, or other custom defined unit) etc.

In some embodiments, methods and systems described herein may be used to measure effectiveness of customer service organizations. In one of these embodiments, customers can be given the option to directly thank a particular customer service representative by leaving a Thank You on their profile after an interaction with the said representative.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), an electronic device, and a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, Python, Ruby, Scala or in any byte code language such as JAVA. The software programs may be stored on or in one or more articles of manufacture as object code.

Having described certain embodiments of methods and systems for incentivizing, exchanging and tracking expressions of gratitude, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method comprising:
receiving, by a first computing device, from a second computing device associated with a first user, a first expression of gratitude for at least one of a good and a service provided by a second user;
receiving, by the first computing device, from the second computing device, a second expression of gratitude for a second at least one of a good and a service provided by a third user; and
providing, by the first computing device, to a third computing device associated with a fourth user, the first expression of gratitude and the second expression of gratitude for display to the fourth user.

2. The method of claim 1 further comprising transmitting, by the first computing device, the first expression of gratitude to the second user.

3. The method of claim 2 further comprising transmitting, by the first computing device, a gift to the second user with the first expression of gratitude.

4. The method of claim 1 further comprising associating, by the first computing device, a plurality of expressions of gratitude with the second user.

5. The method of claim 4 further comprising providing, by the first computing device, to a fourth computing device associated with a fifth user, a subset of the plurality of expressions for display to the fifth user, the second user and the fifth user each identified in an enumeration of users in a community.

6. The method of claim 1 further comprising transmitting, by the first computing device, a gift and the second expression of gratitude to the third user.

7. The method of claim 1 further comprising transmitting, by the first computing device, to the second computing device, a recommendation for at least one of the first user and the fourth user, based upon a characteristic of the second user.

8. The method of claim 1 further comprising transmitting, by the first computing device, to the second computing device, a recommendation for at least one of the first user and the fourth user, based upon a type of the expression of gratitude.

9. The method of claim 1 further comprising identifying, by the first computing device, a type of the expression of gratitude.

10. The method of claim 1 further comprising receiving, by the first computing device, an identification of a type of the expression of gratitude.

11. The method of claim 1 further comprising determining, by the first computing device, to reject the first expression of gratitude, based upon a limitation on a number of expressions the first user is authorized to send.

12. A computer readable medium having instructions thereon that when executed provide a method, the computer readable medium comprising:
instructions to receive, by a first computing device, from a second computing device associated with a first user, a first expression of gratitude for at least one of a good and a service provided by a second user;
instructions to receive, by the first computing device, from the second computing device, a second expression of gratitude for a second at least one of a good and a service provided by a third user; and
instructions to provide, by the first computing device, to a third computing device associated with a fourth user, the first expression of gratitude and the second expression of gratitude for display to the fourth user.

13. A method comprising:
receiving, by a first computing device, from a second computing device associated with a first user, an expression of gratitude for at least one of a good and a service provided by a second user;
transmitting, by the first computing device, the expression of gratitude to a third computing device associated with the second user; and
modifying, by the first computing device, a score associated with the second user, based on the expression of gratitude.

14. The method of claim 13 further comprising modifying, by the first computing device, the score associated with the first user, based on the expression of gratitude.

15. The method of claim 13 further comprising:
receiving, by the first computing device, from a fourth computing device associated with a third user, a second expression of gratitude for a second at least one of a good and a service provided by the second user, the third user and the second user each identified in an enumeration of users in a community; and
generating, by the first computing device, a second score for the second user based on the second expression of gratitude.

16. The method of claim 13 further comprising identifying, by the first computing device, a level of influence of the second user on a plurality of users, based upon the score.

17. The method of claim 13 further comprising identifying, by the first computing device, a level of trust of the second user by the first user, based upon the score.

18. The method of claim 13 further comprising identifying, by the first computing device, a level of impact of the second user on a plurality of users, based upon the score.

19. The method of claim 13 further comprising associating, by the first computing device, a plurality of expressions of gratitude with the second user.

20. The method of claim 19 further comprising providing, by the first computing device, to a fourth computing device associated with a third user, a subset of the plurality of expressions for display to the fourth user, the second user and the fourth user each identified in an enumeration of users in a community.

21. The method of claim 13, wherein transmitting further comprises transmitting a gift to the second user with the expression of gratitude.

22. The method of claim 13 further comprising transmitting, by the first computing device, to at least one of the first user and a third user, a recommendation based upon a characteristic of the second user.

23. The method of claim 13 further comprising transmitting, by the first computing device, to at least one of the first user and a third user, a recommendation based upon a type of the expression of gratitude.

24. The method of claim 13 further comprising transmitting, by the first computing device, to the third computing device, a recommendation for the second user, based upon a characteristic of the first user.

25. The method of claim 13 further comprising transmitting, by the first computing device, to the third computing device, a recommendation for the second user, based upon a type of the expression of gratitude.

26. The method of claim 13 further comprising transmitting, by the first computing device, to the third computing device, an identification of a reward for the second user, based upon the score.

27. The method of claim 13 further comprising identifying, by the first computing device, a type of the expression of gratitude.

28. The method of claim 13 further comprising receiving, by the first computing device, an identification of a type of the expression of gratitude.

29. The method of claim 13 further comprising generating, by the first computing device, a second score based upon a type of the expression of gratitude.

30. A computer readable medium having instructions thereon that when executed provide a method, the computer readable medium comprising:
instructions to receive, by a first computing device, from a second computing device associated with a first user, an expression of gratitude for at least one of a good and a service provided by a second user;
instructions to transmit, by the first computing device, the expression of gratitude to a third computing device associated with the second user; and
instructions to modify, by the first computing device, a score associated with the second user, based on the expression of gratitude.

31. A method comprising:
receiving, by a first computing device, from a second computing device associated with a first user, an expression of gratitude for at least one of a good and a service provided by a second user;
transmitting, by the first computing device, the expression of gratitude to a third computing device associated with the second user; and
adding, by the first computing device, an identification of the first user to an enumeration of users associated with the second user.

32. The method of claim 31, wherein transmitting further comprises transmitting a gift to the second user with the expression of gratitude.

33. The method of claim 31 further comprising transmitting, by the first computing device, to at least one of the first user and a third user, a recommendation based upon a characteristic of the second user.

34. The method of claim 31 further comprising transmitting, by the first computing device, to at least one of the first user and a third user, a recommendation based upon a type of the expression of gratitude.

35. The method of claim 31 further comprising transmitting, by the first computing device, to the third computing device, a recommendation for the second user, based upon a characteristic of the first user.

36. The method of claim 31 further comprising transmitting, by the first computing device, to the third computing device, a recommendation for the second user, based upon a type of the expression of gratitude.

37. The method of claim 31 further comprising adding, by the first computing device, an identification of the second user to an enumeration of users associated with the first user.

38. The method of claim 31 further comprising identifying, by the first computing device, a type of the expression of gratitude.

39. The method of claim 31 further comprising receiving, by the first computing device, an identification of a type of the expression of gratitude.

40. A computer readable medium having instructions thereon that when executed provide a method, the computer readable medium comprising:
instructions to receive, by a first computing device, from a second computing device associated with a first user, an expression of gratitude for at least one of a good and a service provided by a second user;
instructions to transmit, by the first computing device, the expression of gratitude to a third computing device associated with the second user; and
instructions to add, by the first computing device, an identification of the first user to an enumeration of users associated with the second user.

41. A method comprising:
importing, by a computing device, data identifying a relationship between a first user and a second user;
automatically generating, by the computing device, an expression of gratitude from the first user to the second user, based upon the imported data; and
creating, by the computing device, a relationship between two users based on the automatically-generated expression of gratitude.

42. A method comprising:
providing, by a first computing device, to a second computing device associated with a first user, an enumeration of opportunities to provide at least one of a good and a service in exchange for at least one expression of gratitude;
receiving, by the first computing device, from a third computing device associated with a second user, an expression of gratitude for the at least one of the good and the service provided by the first user; and
providing, by the first computing device, to the second computing device, first expression of gratitude.

43. A method comprising:
providing, by a first computing device, to a second computing device associated with a first user, an enumeration of offers to provide an expression of gratitude in exchange for receiving at least one of a good and a service;
receiving, by the first computing device, from the second computing device, the expression of gratitude for the at least one of the good and the service provided by a second user; and
providing, by the first computing device, to a third computing device, associated with the second user, the expression of gratitude.

44. The method of claim 43 further comprising adding, by the first computing device, an identification of the first user to an enumeration of users associated with the second user.

45. The method of claim 43 further comprising adding, by the first computing device, an identification of the second user to an enumeration of users associated with the first user.

46. The method of claim 43 further comprising modifying, by the first computing device, a score associated with the second user, based on the expression of gratitude.

47. The method of claim 43 further comprising modifying, by the first computing device, a score associated with the first user, based on the expression of gratitude.

48. The method of claim 43 further comprising providing, by the first computing device, to a third computing device associated with a fourth user, the first expression of gratitude and the second expression of gratitude for display to the fourth user.

49. A method comprising:
receiving, by a first computing device, from a second computing device associated with a first user, an expression of gratitude for value provided by an object; and
providing, by the first computing device, to a third computing device associated with a second user, the expression of gratitude for display to the second user.

50. The method of claim 49 further comprising transmitting, by the first computing device, the expression of gratitude to a fourth computing device associated with the object.

51. The method of claim 50 further comprising transmitting, by the first computing device, a gift with the expression of gratitude to the fourth computing device associated with the object.

52. The method of claim 49 further comprising associating, by the first computing device, a plurality of expressions of gratitude with the object.

53. The method of claim 52 further comprising providing, by the first computing device, to a fourth computing device associated with a third user, a subset of the plurality of expressions for display on the fourth computing device, the object identified in an enumeration of objects.

54. The method of claim 49 further comprising transmitting, by the first computing device, to at least one of the first user and the second user, a recommendation based upon a characteristic of the object.

55. The method of claim 49 further comprising transmitting, by the first computing device, to at least one of the first user and the second user, a recommendation based upon a type of the expression of gratitude.

56. The method of claim 49 further comprising transmitting, by the first computing device, to a fourth computing device, a recommendation for the object, based upon a characteristic of the first user.

57. The method of claim 49 further comprising identifying, by the first computing device, a type of the expression of gratitude.

58. The method of claim 49 further comprising receiving, by the first computing device, an identification of a type of expression of gratitude.

59. The method of claim 49 further comprising modifying, by the first computing device, a score associated with the object, based on the expression of gratitude.

60. The method of claim 59 further comprising identifying, by the first computing device, a level of influence of the object on a plurality of users, based on the score.

61. The method of claim 59 further comprising identifying, by the first computing device, a level of impact of the object on a plurality of users, based on the score.

62. The method of claim 49 further comprising adding, by the first computing device, an identification of the object to an enumeration of objects associated with the first user.

63. The method of claim 49 further comprising adding, by the first computing device, an identification of the first user to an enumeration of users associated with the object.

64. A computer readable medium having instructions thereon that when executed provide a method, the computer readable medium comprising:
instructions to receive, by a first computing device, from a second computing device associated with a first user, an expression of gratitude for value provided by a object;
instructions to transmit, by the first computing device, the expression of gratitude to a third computing device associated with the object; and
instructions to add, by the first computing device, an identification of the first user to an enumeration of users associated with the object.
